(19) United States
(12) Patent Application Publication
(10) Pub. No.: US 2014/0093064 A1
(43) Pub. Date: Apr. 3, 2014

(54) COMMUNICATION PROCESSING SYSTEM, COMMUNICATION PROCESSING METHOD, COMMUNICATION PROCESSING DEVICE, AND CONTROL METHOD AND CONTROL PROGRAM OF COMMUNICATION PROCESSING DEVICE

(71) Applicants: Kenichi Kamiya, Tokyo (JP); Kazuhiro Okanoue, Tokyo (JP); Hiroshi Terasaki, Tokyo (JP); Mitsunori Morisaki, Tokyo (JP)

(72) Inventors: Kenichi Kamiya, Tokyo (JP); Kazuhiro Okanoue, Tokyo (JP); Hiroshi Terasaki, Tokyo (JP); Mitsunori Morisaki, Tokyo (JP)

(73) Assignee: NEC CORPORATION, Minato-ku, Tokyo (JP)

(21) Appl. No.: 14/119,623

(22) PCT Filed: May 15, 2012
(86) PCT No.: PCT/JP2012/003149

§ 371 Date: Nov. 22, 2013

(30) Foreign Application Priority Data
May 24, 2011 (JP) 2011-115924

(51) Int. Cl. H04M 3/523

(52) U.S. Cl. CPC H04M 3/5235
USPC 379/265.12; 379/265.13

(57) ABSTRACT

A communication processing system according to the present invention is a communication processing system including user communication terminals each operated by a user and responder communication terminals each operated by a responder responding to an inquiry from the user. The communication processing system includes: a responder communication terminal information storing means for associating and storing each of the responder communication terminals and a responder attribute of the responder operating the responder communication terminal; and a connection controlling means for controlling to search the responder attribute corresponding to a user attribute of the user by referring to the responder communication terminal information storing means and connect the responder communication terminal associated with the responder attribute to the user communication terminal.

### TECHNICAL FIELD

The present invention relates to a communication technique for responding to inquiries by the general public via a network.

### BACKGROUND ART

In the field of the abovementioned technique, a technique disclosed in Patent Document 1 is known. In this technique, for initiating a contact via a line, a caller transfers a media attribute value to a designated receiver, and the receiver notifies acceptance of a call corresponding to the received attribute value.
Patent Document 1: Japanese Unexamined Patent Application Publication No. H11-027347

However, in the abovementioned conventional technique, when a caller does not designate a receiver, it is impossible to select a receiver to accept a call based on the attribute of the caller. Moreover, when a responder (also referred to as an operator hereinafter) to receive changes and the attribute also changes, it is impossible to select a receiver to accept a call.

### SUMMARY

An object of the present invention is to provide a technique to solve the abovementioned issues.

In order to achieve the abovementioned object, a communication processing system according to the present invention is a communication processing system including user communication terminals each operated by a user and responder communication terminals each operated by a responder responding to an inquiry from the user. The communication processing system includes:

a responder communication terminal information storing means for associating and storing each of the responder communication terminals and a responder attribute of the responder operating the responder communication terminal; and

a connection controlling means for controlling to search the responder attribute corresponding to a user attribute of the user by referring to the responder communication terminal information storing means and connect the responder communication terminal associated with the responder attribute to the user communication terminal.

In order to achieve the object, a communication processing method according to the present invention is a method for communication processing by a communication processing system including user communication terminals each operated by a user and responder communication terminals each operated by a responder responding to an inquiry from the user, and the communication processing system includes a responder communication terminal information storing means for associating and storing each of the responder communication terminals and a responder attribute of the responder operating the responder communication terminal.

The method includes controlling to search the responder attribute corresponding to a user attribute of the user by referring to the responder communication terminal information storing means and connect the responder communication terminal associated with the responder attribute to the user communication terminal.

In order to achieve the object, a communication processing device according to the present invention includes:

a responder communication terminal information storing means for associating and storing each of responder communication terminals each operated by a responder responding to an inquiry from a user and a responder attribute of the responder operating the responder communication terminal; and

a connection controlling means for controlling to search the responder attribute corresponding to a user attribute of the user by referring to the responder communication terminal information storing means and connect the responder communication terminal associated with the responder attribute to the user communication terminal operated by the user.

In order to achieve the object, a control method according to the present invention is a method for control by a communication processing device including a responder communication terminal information storing means for associating and storing each of responder communication terminals each operated by a responder responding to an inquiry from a user and a responder attribute of the responder operating the responder communication terminal.

The method includes controlling to search the responder attribute corresponding to a user attribute of the user by referring to the responder communication terminal information storing means and connect the responder communication terminal associated with the responder attribute to the user communication terminal operated by the user.

In order to achieve the object, a computer program according to the present invention includes instructions for causing a communication processing device, which includes a responder communication terminal information storing means for associating and storing each of responder communication terminals each operated by a responder responding to an inquiry from a user and a responder attribute of the responder operating the responder communication terminal, to realize a connection controlling means for controlling to search the responder attribute corresponding to a user attribute of the user by referring to the responder communication terminal information storing means and connect the responder communication terminal associated with the responder attribute to the user communication terminal operated by the user.

According to the present invention, even if a responder as a receiver changes and the attribute also changes, it is possible to select a receiver to be called based on the attribute of an inquirer.

### BRIEF DESCRIPTION OF DRAWINGS

FIG. 1 is a block diagram showing the configuration of a communication processing system according to a first exemplary embodiment of the present invention;

FIG. 2 is a diagram showing the outline of a communication processing system according to a second exemplary embodiment of the present invention;

FIG. 3 is a block diagram showing the configuration of the communication processing system according to the second exemplary embodiment of the present invention;

FIG. 4 is a block diagram showing the configuration of an inquiry terminal and an operator terminal according to the second exemplary embodiment of the present invention;

FIG. 5 is a block diagram showing the configuration of a communication processing system according to the second exemplary embodiment of the present invention;

FIG. 6A is a diagram showing the configuration of an operator attribute storing part according to the second exemplary embodiment of the present invention;

FIG. 6B is a diagram showing the configuration of operator terminal use information according to the second exemplary embodiment of the present invention;

FIG. 6C is a diagram showing the configuration of an operator terminal/operator attribute storing part according to the second exemplary embodiment of the present invention;

FIG. 7 is a diagram showing the configuration of an inquirer attribute storing part according to the second exemplary embodiment of the present invention;

FIG. 8 is a diagram showing the configuration of content DB according to the second exemplary embodiment of the present invention;

FIG. 9 is a sequence diagram showing an operational procedure by the communication processing system according to the second exemplary embodiment of the present invention;

FIG. 10A is a sequence diagram showing operational steps for initial setup by the inquiry terminal according to the second exemplary embodiment of the present invention;

FIG. 10B is a sequence diagram showing operational steps for initial setup by the operator terminal according to the second exemplary embodiment of the present invention;

FIG. 11 is a sequence diagram showing operational steps for inquiry processing by the communication processing system according to the second exemplary embodiment of the present invention;

FIG. 12 is a block diagram showing the hardware configuration of the communication processing device according to the second exemplary embodiment of the present invention;

FIG. 13A is a diagram showing a display screen of the inquiry terminal according to the second exemplary embodiment of the present invention;

FIG. 13B is a diagram showing a display screen of the operator terminal according to the second exemplary embodiment of the present invention;

FIG. 14A is a flowchart showing a processing procedure by the communication processing device according to the second exemplary embodiment of the present invention;

FIG. 14B is a flowchart showing the processing procedure by the communication processing device according to the second exemplary embodiment of the present invention;

FIG. 15 is a block diagram showing the configuration of a communication processing device according to a third exemplary embodiment of the present invention;

FIG. 16 is a diagram showing the configuration of an operator terminal/operator attribute storing part according to the third exemplary embodiment of the present invention;

FIG. 17 is a flowchart showing a processing procedure by the communication processing device according to the third exemplary embodiment of the present invention;

FIG. 18 is a diagram showing the configurations of an operator terminal/operator attribute storing part and an inquirer attribute storing part according to a fourth exemplary embodiment of the present invention;

FIG. 19 is a diagram showing the configuration of information representing an operator processing status according to a fifth exemplary embodiment of the present invention;

FIG. 20 is a flowchart showing a processing procedure by a communication processing device according to the fifth exemplary embodiment of the present invention; and

FIG. 21 is a diagram showing the configurations of an operator terminal/operator attribute storing part and an inquirer attribute storing part according to a sixth exemplary embodiment of the present invention.

### EXEMPLARY EMBODIMENTS

Referring to the drawings, exemplary embodiments of the present invention will be illustratively described below in detail. However, components described in the following exemplary embodiments are mere illustrations and are not for limiting the technical scope of the present invention.

### First Exemplary Embodiment

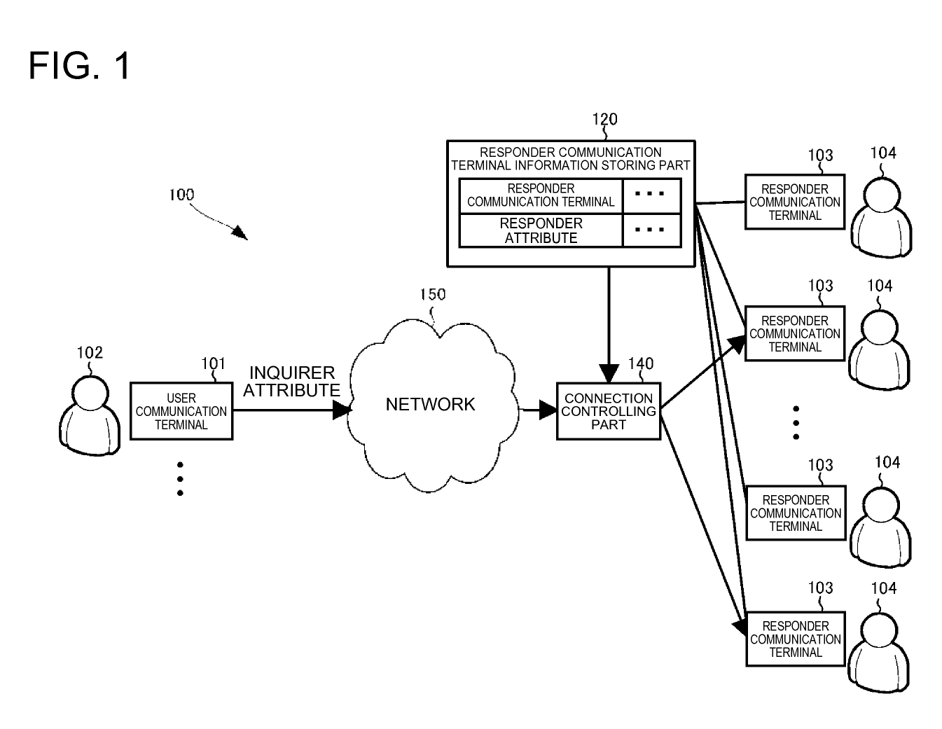

A communication processing system 100 as a first exemplary embodiment of the present invention will be described referring to FIG. 1. The communication processing system 100 is a system including a user communication terminal 101 operated by a user 102 and a responder communication terminal 103 operated by a responder 104 who responds to an inquiry from the user 102.

As shown in FIG. 1, the communication processing system 100, which is the communication processing system 100 including the user communication terminal 101 operated by the user 102 and the responder communication terminal 103 operated by the responder 104 responding to an inquiry from the user 102, includes: a responder communication terminal information storing part 120 that stores the responder communication terminals 103 and the attributes of the responders 104 operating the responder communication terminals 103 in association with each other; and a connection controlling part 140 that searches the attribute of the responder 104 corresponding to the attribute of the user 102 by referring to the responder communication terminal information storing part 120, and controls to connect the responder communication terminal 103 associated with the attribute of the responder 104 and the user communication terminal 101.

According to this exemplary embodiment, even if a responder to receive changes and the attribute of the responder 104 changes, it is possible to select the responder communication terminal 103 to be called based on the attribute of the user 102.

### Second Exemplary Embodiment

Next, a communication processing system according to a second exemplary embodiment of the present invention will be described. In this exemplary embodiment, when an inquirer (a user) inquires by using an inquiry terminal (a user communication terminal) placed in an airport, a language that the inquirer wants to speak for inquiry is notified as the attribute of the inquirer. Then, a communication processing device refers to operator information registered in an operator terminal (a responder communication terminal), selects an operator terminal capable of responding in the notified language, and informs the operator terminal. Upon reception of assent to respond by the operator (responder) from the operator terminal, the communication processing device connects the inquirer with the operator, and causes to start an inquiry.

According to this exemplary embodiment, because an operator terminal registered by an operator capable of responding in a used language that is the attribute of an inquirer is informed of inquiry notification, communication does not become unavailable due to a difference of the language even if the operator changes. Thus, a proper connection between an inquirer and an operator can be realized without needless operation such as confirmation of used languages with each other.

### <Outline of Communication Processing System of This Exemplary Embodiment>

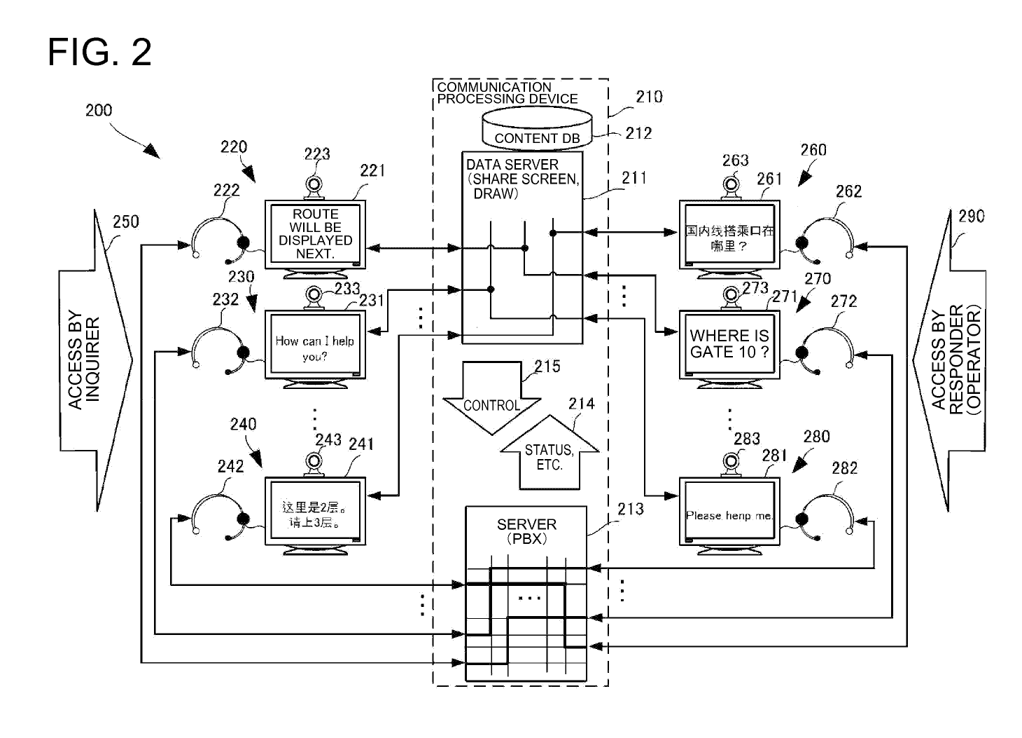

FIG. 2 is a diagram showing the outline of a communication processing system 200 according to this exemplary embodiment. Although this exemplary embodiment describes an inquiry terminal as a terminal placed in an airport, a similar system for inquiry is also effectively employed in public facilities where many languages are used, such as a hotel. Moreover, the communication processing system 200 may be used in any use conditions, not only for an inquiry by an inquirer.

The communication processing system 200 is composed of three major portions as follows. One of them includes a plurality of inquiry terminals 220 to 240 each accepting an input of an inquiry content and outputting a response thereto. Another one of them includes a plurality of operator terminals 260 to 280 each accepting access by a responder (an operator) 290 corresponding to an inquiry and outputting the attribute of the operator, and also outputting an inquiry by an inquirer and accepting an input by an operator. The other of them is a communication processing device 210 connecting an inquirer and an operator in accordance with the attributes thereof.

The inquiry terminals 220 to 240 have display parts 221 to 241, headsets 222 to 242, and video cameras 223 to 243 for capturing images of inquirers, respectively. Also, the operator terminals 260 to 280 have display parts 261 to 281, headsets 262 to 282, and video cameras 263 to 283 for capturing images of inquirers, respectively. Instead of the headset, a microphone and a speaker may be separately provided. Alternatively, a speaker that produces a speech sound corresponding to an image displayed on the display part may be provided separately from the headset, which is used for a talk between an inquirer and an operator. For example, it is desirable that an instruction to operate a menu or the like is given through this speaker. Further, a microphone for operation instruction may be additionally provided. Besides, each of the display parts 221 to 241 has an inputting part (a user inputting means), such as a touchscreen panel, that accepts an input by an inquirer. Likewise, each of the display parts 261 to 281 has an inputting part (a responder inputting means), such as a touchscreen panel, that accepts an input by an operator. The inputting part is not limited to a touchscreen panel, and may additionally have a keyboard, a mouse and so on.

The communication processing device 210 includes a data server 211 for controlling display of images on the display parts and capture of images by the video cameras in the inquiry terminals and the operator terminals, and a speech server (PBX) 213 for controlling input and output of speech sounds of the headsets in the inquiry terminals and the operator terminals. Further, the communication processing device 210 has content database (abbreviated as DB, hereinafter) 212 serving as a content storing part storing content such as images, video images, speech sounds and letters provided to an inquirer and content that an inquirer and an operator should share information. Speech connection by the server (PBX) 213 is subjected to control 215 by the data server 211, and a connection status is returned from the server (PBX) 213 for control of the data server 211.

In FIG. 2, a typical processing condition in the communication processing system 200 is shown by display screens of the display parts 221 to 241 and the display parts 261 to 281 and by a connection state between the data server 211 and the server (PBX) 213.

In FIG. 2, the inquiry terminal 220 used by an inquirer speaking Japanese is connected with the operator terminal 270 that an operator capable of speaking Japanese has registered and agreed to respond. Moreover, the inquiry terminal 230 used by an inquirer speaking English is connected with the operator terminal 280 that an operator capable of speaking English has registered and agreed to respond. Moreover, the inquiry terminal 240 used by an inquirer speaking Chinese is connected with the operator terminal 260 that an operator capable of speaking Chinese has registered and agreed to respond. The used languages are displayed on the display screens, respectively, and communication is performed with ease. FIG. 2 shows a case where each language corresponds to one terminal. However, the feature of this exemplary embodiment is that, in a case where operators capable of speaking a certain language are registered to a plurality of operator terminals, a used language is notified by an inquirer to the operator terminals and connection is established based on agreement by any one of the operators.

With this configuration, an inquirer can smoothly start communication in his/her language without any operation. On the other hand, an operator can recognize without any operation that the inquirer is requesting communication in a language that the operator can speak. Thus, the operator does not need to change with another operator capable of speaking the language used by the inquirer, and consequently, can accept an inquiry with efficiency without keeping the inquirer wait. Also in a case where an operator is a multilingual person who can speak a plurality of languages, the operator can know without any operation what language an inquirer wants to communicate in among the languages that the operator can speak.

### <Configuration of Communication Processing System>

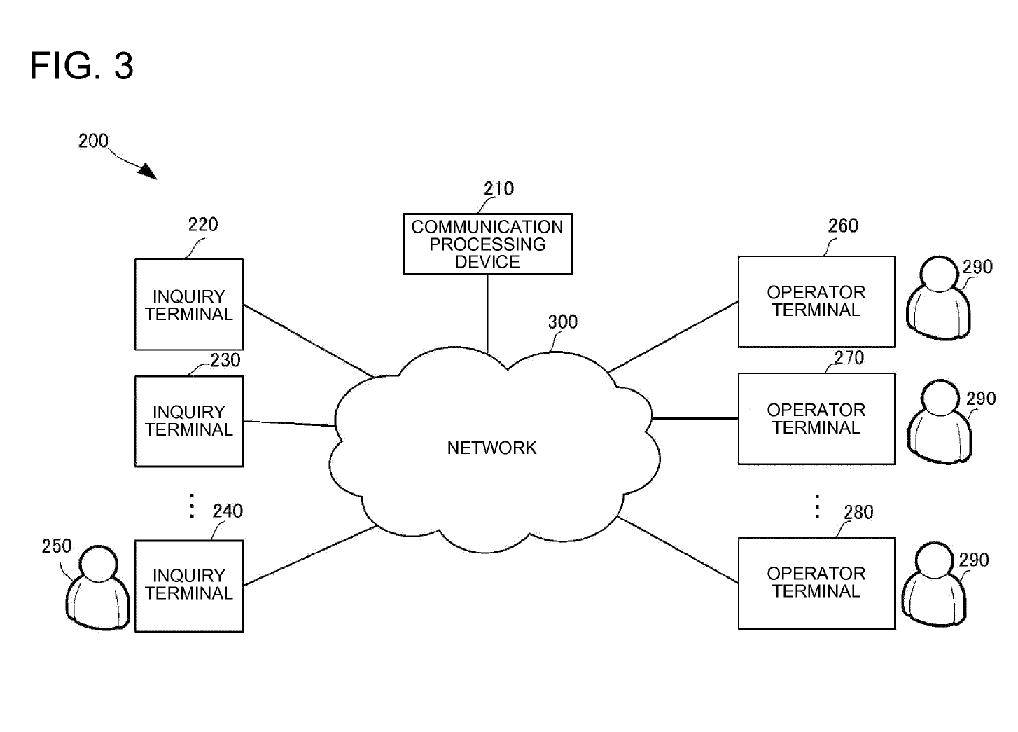

FIG. 3 is a block diagram showing the configuration of the communication processing system 200 according to this exemplary embodiment.

The communication processing system 200 has the inquiry terminals 220 to 240 each used by an inquirer 250, the operator terminals 260 to 280 each used by an operator 290, and the communication processing device 210 controlling connection between the inquiry terminals and the operator terminals. Below, the functional configurations of the respective structural elements will be described.

### (Configurations of Inquiry Terminal and Operator Terminal)

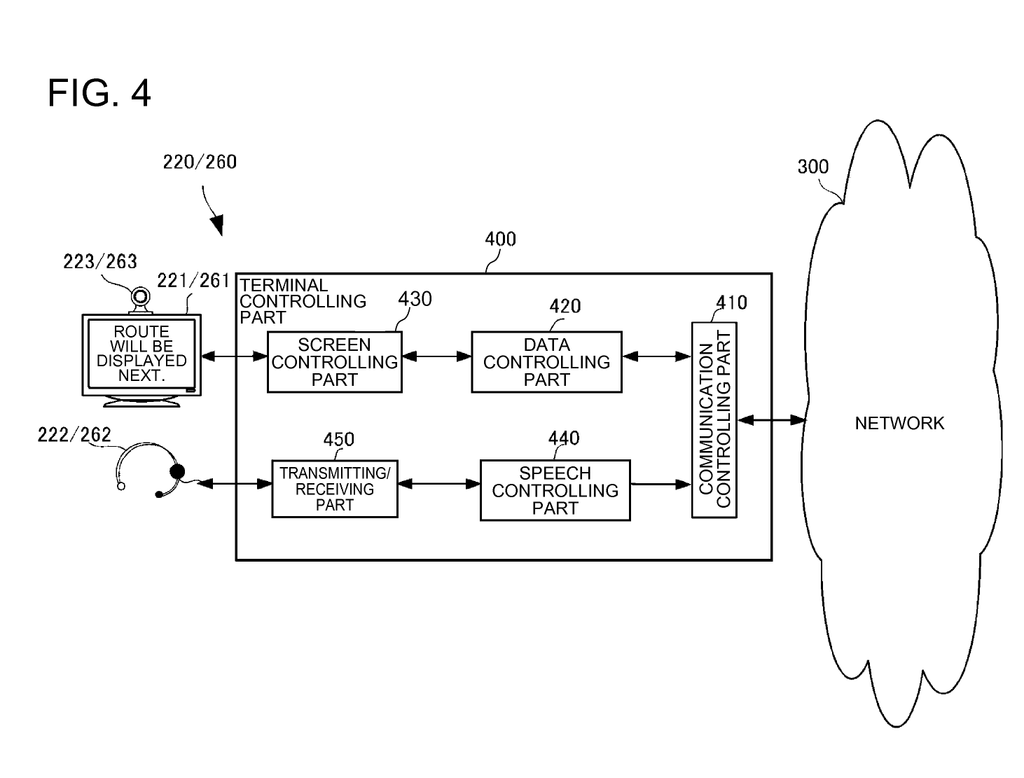

FIG. 4 is a block diagram showing the configurations of the inquiry terminal 220 and the operator terminal 260 according to this exemplary embodiment. The inquiry terminal 220 and the operator terminal 260 will be described as the representatives because the inquiry terminals 230, 240 and the operator terminals 270, 280 have the same configurations.

A common terminal controlling part 400 has a communication controlling part 410 controlling communication performed via a network 300. Information communicated by the communication controlling part 410 is divided into data and a speech sound. A data controlling part 420 performs control such as encoding and decoding of the data. A screen controlling part 430 generates screen data based on the data passed from the data controlling part 420 and displays on the display part 221/261. Moreover, the screen controlling part 430 sends instruction data to the data controlling part 420 based on an instruction passed from the display part 221/261. On the other hand, a speech controlling part 440 performs control such as compression of speech. A transmitting/receiving part 450 converts the speech passed from the speech controlling part 440 into reproduced signals, and outputs a speech sound through the headset 222/262. Moreover, the transmitting/receiving part 450 transmits speech data to the speech controlling part 440 based on speech input through the microphone of the headset 222/262. The terminal controlling part 400 can be realized by a versatile computer, for example, a personal computer.

The display part 221/261, the headset 222/262, and the video camera 223/263 are the same as shown in FIG. 2.

### (Configuration of Communication Processing Device)

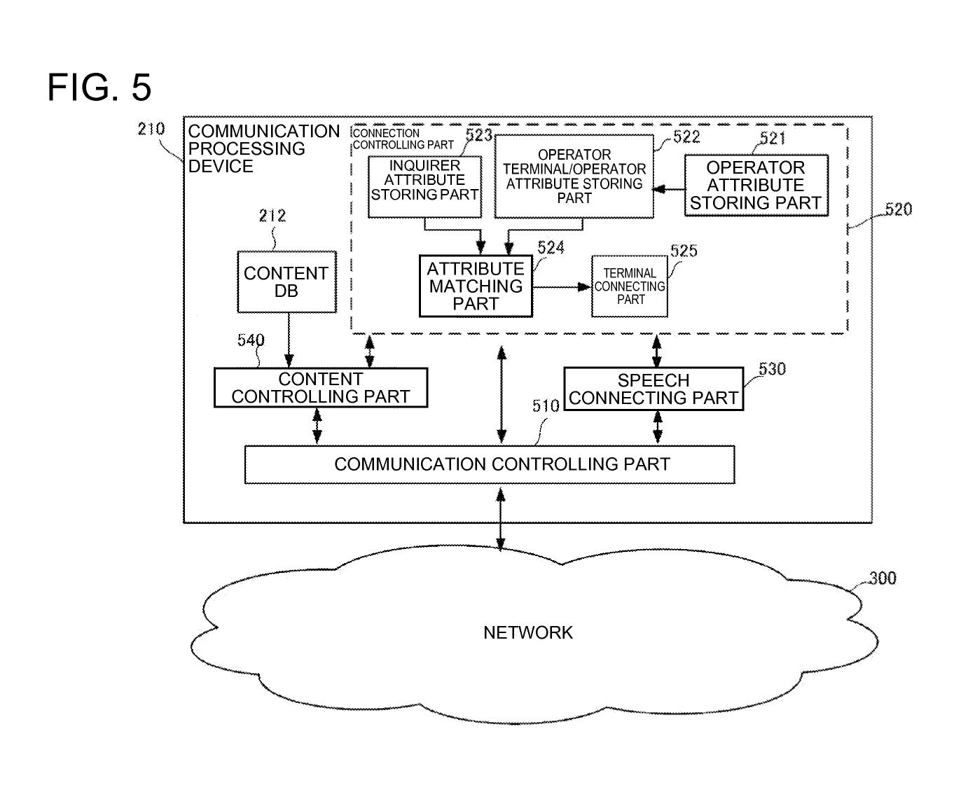

FIG. 5 is a block diagram showing the configuration of the communication processing device 210 according to this exemplary embodiment.

The communication processing device 210 has a communication controlling part 510 controlling communication performed via the network 300. Information communicated by the communication controlling part 510 is divided into data and a speech sound. A content controlling part 540 performs control such as encoding of data passed from the content DB 212. On the other hand, a speech connecting part 530 controls speech connection between the inquiry terminals and the operator terminals.

A connection controlling part 520 controls data connection and speech connection between the inquiry terminal and the operator terminal, based on a language used by an inquirer inputted as the attribute of the inquirer through the inquiry terminal and a language used by an operator (a usable language) registered as the attribute of the operator through the operator terminal. The connection controlling part 520 has the following functional configuration parts. An operator attribute storing part 521 previously stores, for each person working as an operator of the communication processing system 200, a language that the person can speak as the attribute of the person. An operator terminal/operator attribute storing part 522, when an operator registered in the operator attribute storing part 521 starts using any of the operator terminals, stores the attribute of the operator in association with the operator terminal. An inquirer attribute storing part 523 stores a language used for an inquiry inputted by an inquirer through any of the inquiry terminals, in association with the inquiry terminal.

An attribute matching part 524 searches operator terminals used (operated) by operators capable of using a language coincident with (corresponding to) the language used by the inquirer stored in the inquirer attribute storing part 523, from the operator terminal/operator attribute storing part 522. A terminal connecting part 525 informs the operator terminals used by the operators capable of using the language coincident with the language used by the inquirer that an inquiry is made, based on the result of search by the attribute matching part 524. Upon receiving agreement to respond to the inquiry from any of the informed operator terminals, the terminal connecting part 525 connects the operator terminal to the inquiry terminal used by the inquirer.

The communication processing device 210 can be realized by a versatile computer, for example, a personal computer.

### (Operator Attribute Storing Part)

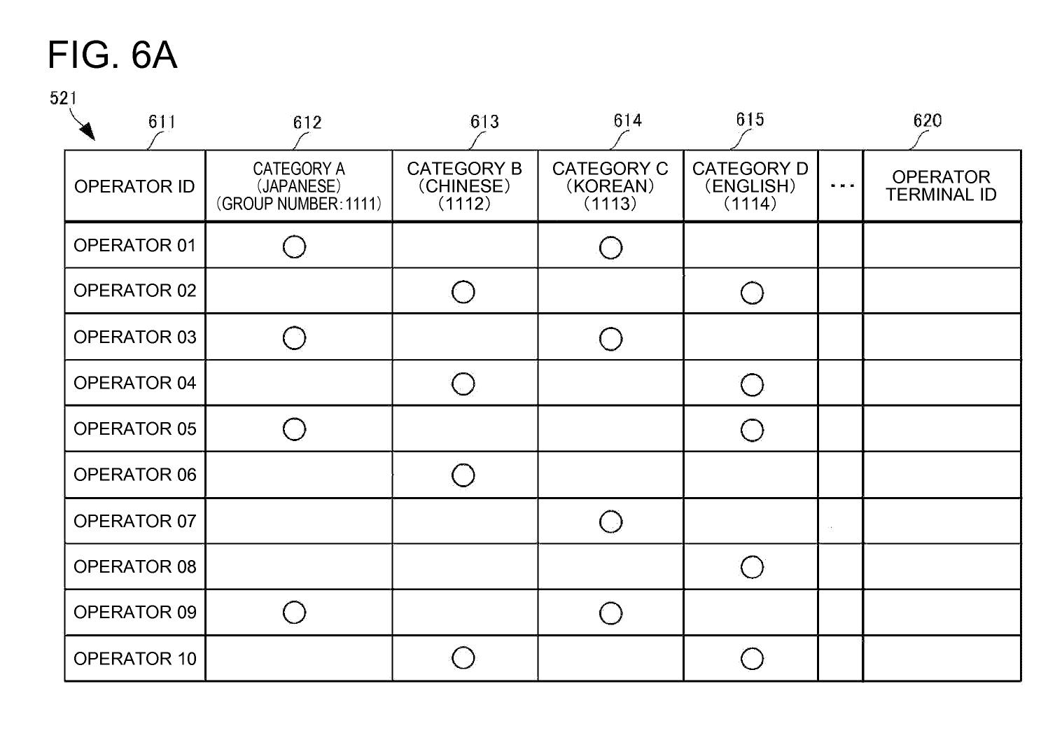

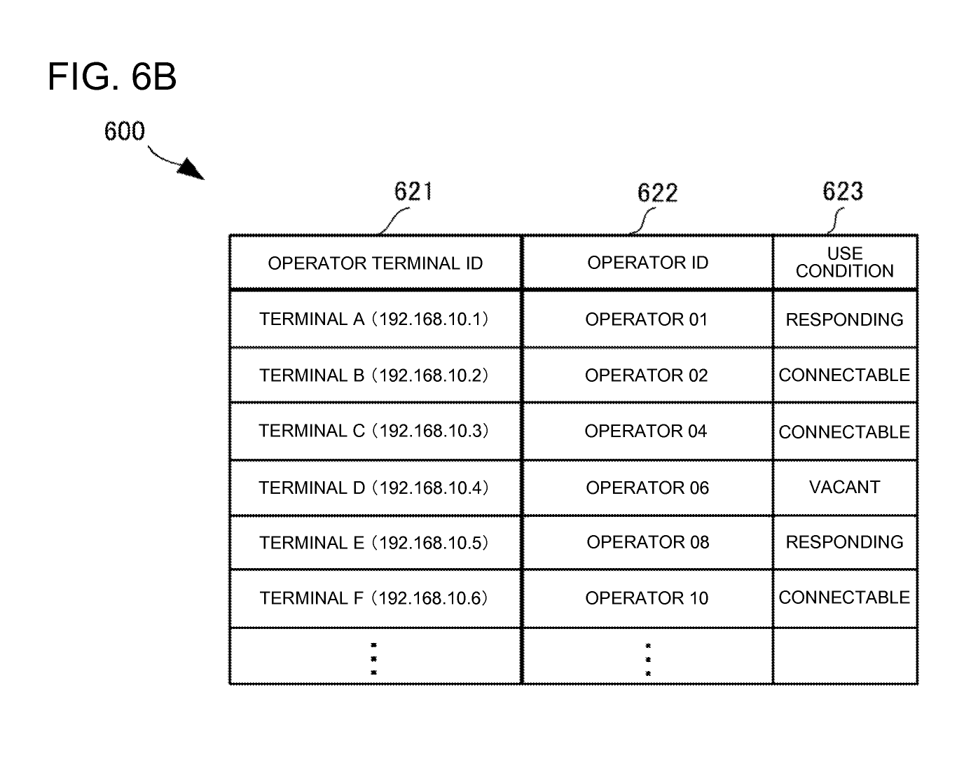

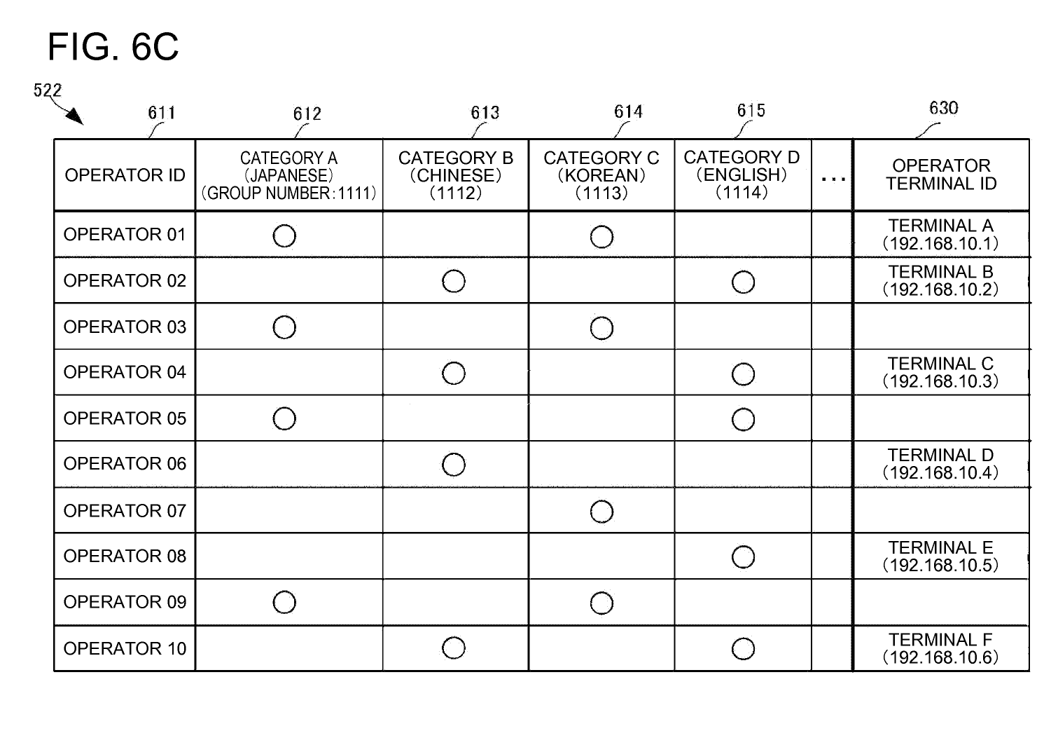

FIG. 6A is a diagram showing the configuration of the operator attribute storing part 521 according to this exemplary embodiment.

The operator attribute storing part 521 stores the kinds of languages, Japanese 612, Chinese 613, Korean 614 and English 615, that the respective operators can use for conversation, in association with operator identifiers (abbreviated as ID, hereinafter) 611. FIG. 6A shows a language that an operator can use with a white circle. FIG. 6A shows the four languages, but languages are not limited to them. Moreover, a region to store an operator terminal ID 620 when an operator uses the operator terminal is prepared.

### (Operator Terminal Use Information)

FIG. 6B is a diagram showing the configuration of operator terminal use information 600 according to this exemplary embodiment.

The operator terminal use information 600 is information showing an operator ID 622 using an operator terminal and an operator terminal use condition 623, in association with an operator terminal ID 621 of the operator terminal. The operator terminal use information 600 is stored, for example, in the operator terminal/operator attribute storing part 522 to be described later referring to FIG. 6C, or in another storing part (not shown in the drawings). The operator terminal use condition 623 includes “responding” (using), “connectable” (operator standby) and “vacant” (operator absent), but is not limited thereto. Moreover, the operator terminal ID 621 may include an IP (Internet Protocol) address.

### (Operator Terminal/Operator Attribute Storing Part)

FIG. 6C is a diagram showing the configuration of the operator terminal/operator attribute storing part 522 according to this exemplary embodiment.

The operator terminal/operator attribute storing part 522 is equivalent to the operator attribute storing part 521 shown in FIG. 6A with a used operator terminal ID 630 stored. The used operator terminal ID (including an IP address) 630 is stored based on the operator terminal use information 600 shown in FIG. 6B. The configuration of the operator terminal/operator attribute storing part 522 is not limited to the configuration shown in FIG. 6C, and may be any configuration that stores the operator ID 611 and a used language in association with the operator terminal ID 630.

### (Inquirer Attribute Storing Part)

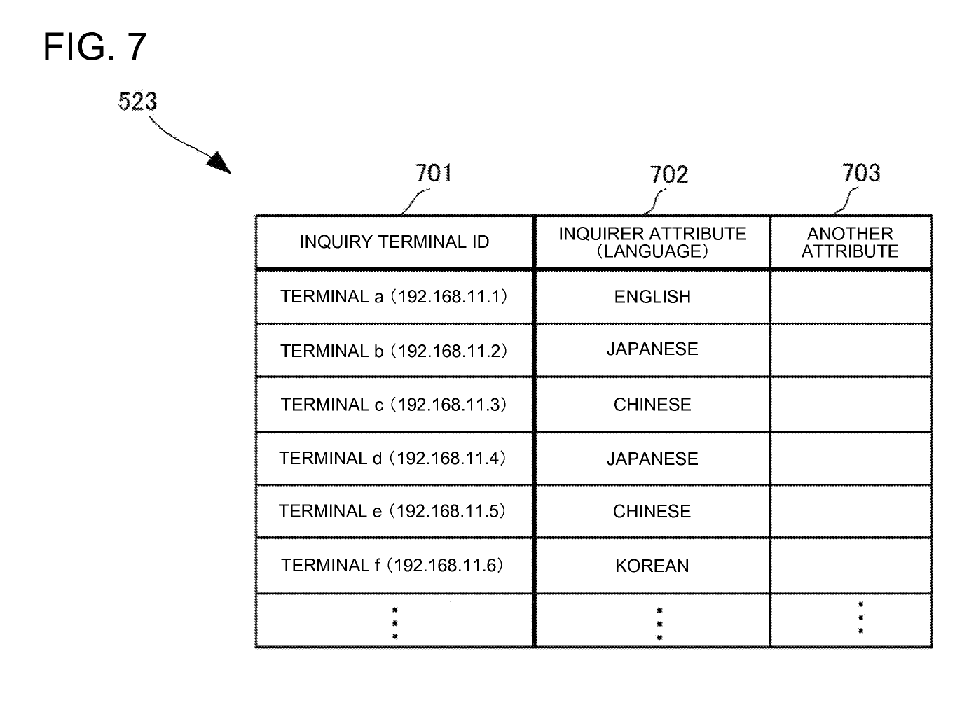

FIG. 7 is a diagram showing the configuration of the inquirer attribute storing part 523 according to this exemplary embodiment.

The inquirer attribute storing part 523 stores a used language 702 as the attribute of an inquirer in association with an inquiry terminal ID 701. The inquirer attribute storing part 523 may further store another attribute 703 (e.g., the gender and age of an inquirer, which will be described later).

### (Content DB)

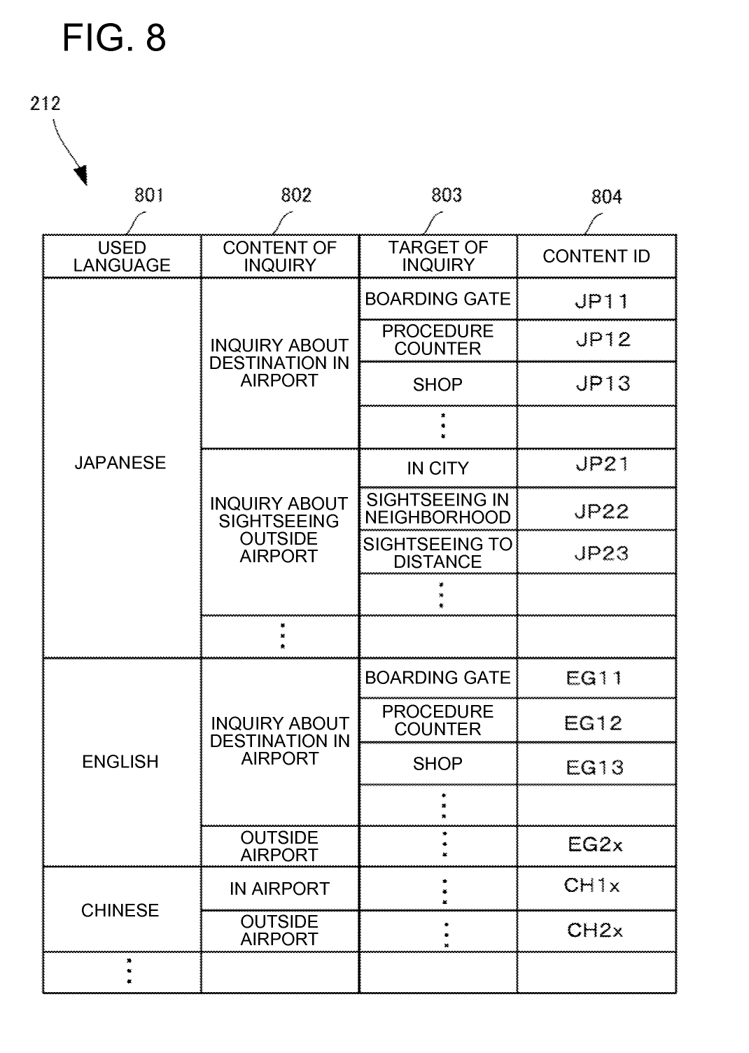

FIG. 8 is a diagram showing the configuration of the content DB 212 according to this exemplary embodiment.

The content DB 212 stores a content ID 804 including a used language in association with a used language 801, an inquiry content 802 and an inquiry target 803. For example, in a case where the used language 801 is Japanese, the inquiry content 802 is an inquiry about sightseeing outside the airport, and the inquiry target 803 is sightseeing in the city, content with the content ID 804 “JP21” (Japanese 21) is used for information. Moreover, in a case where the used language 801 is English, the inquiry content 802 is an inquiry about a destination in the airport, and the inquiry target 803 is the boarding gate, content with the content ID 804 “EG11” (English 11) is used for information. The classification of the used language 801, the inquiry content 802 and the inquiry target 803 is not limited to this example. It is possible to classify in a different way depending on inquiries. Moreover, instead of management of information on a content basis, selection of content, images, speech sounds, letters or the like by keywords may be performed. For example, in response to an inquiry about information in the airport, an operator may select and display an image of a map of the inside of the airport.

### <Operational Procedure by Communication Processing System>

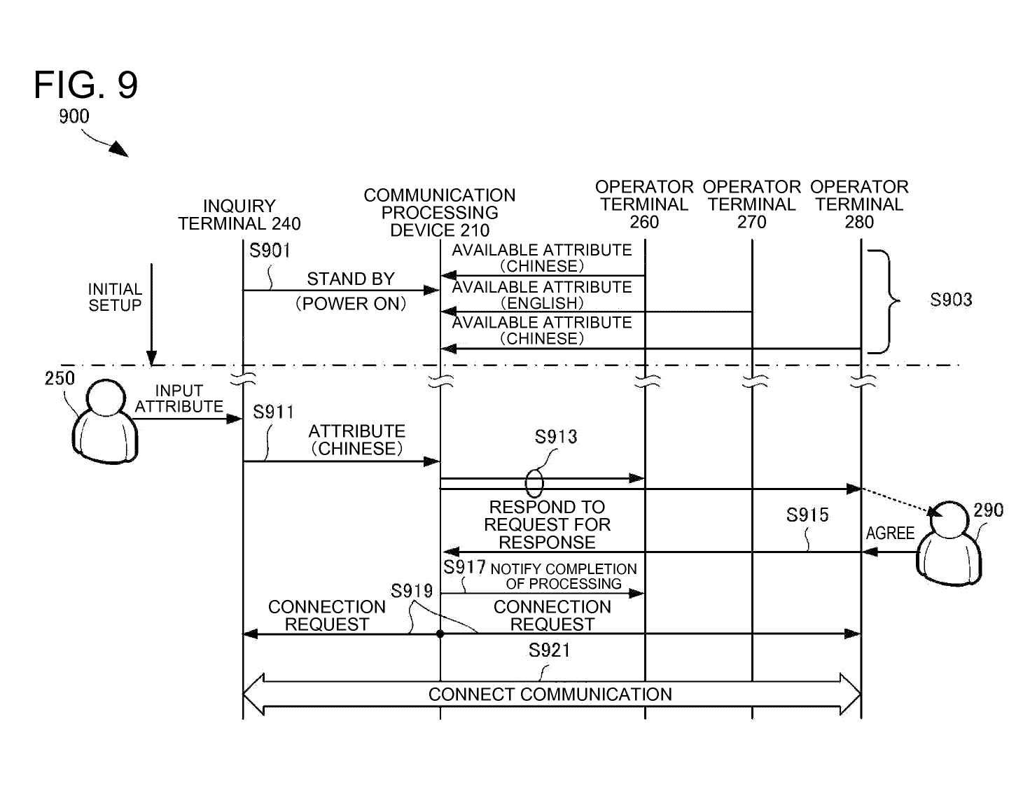

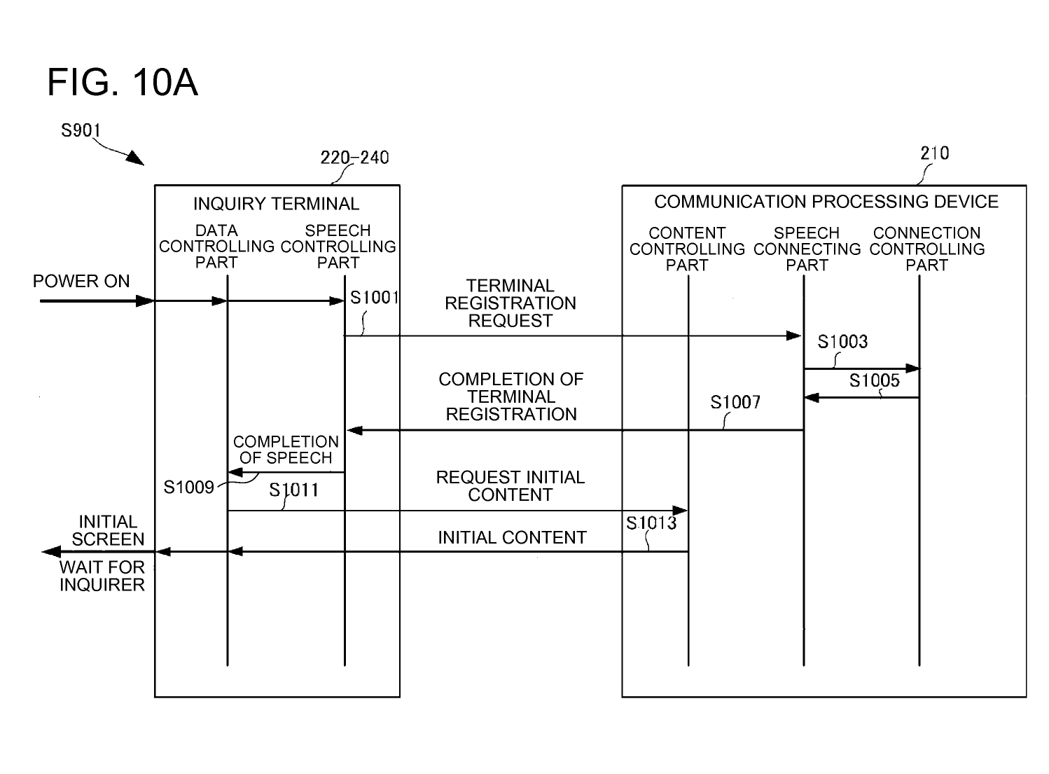

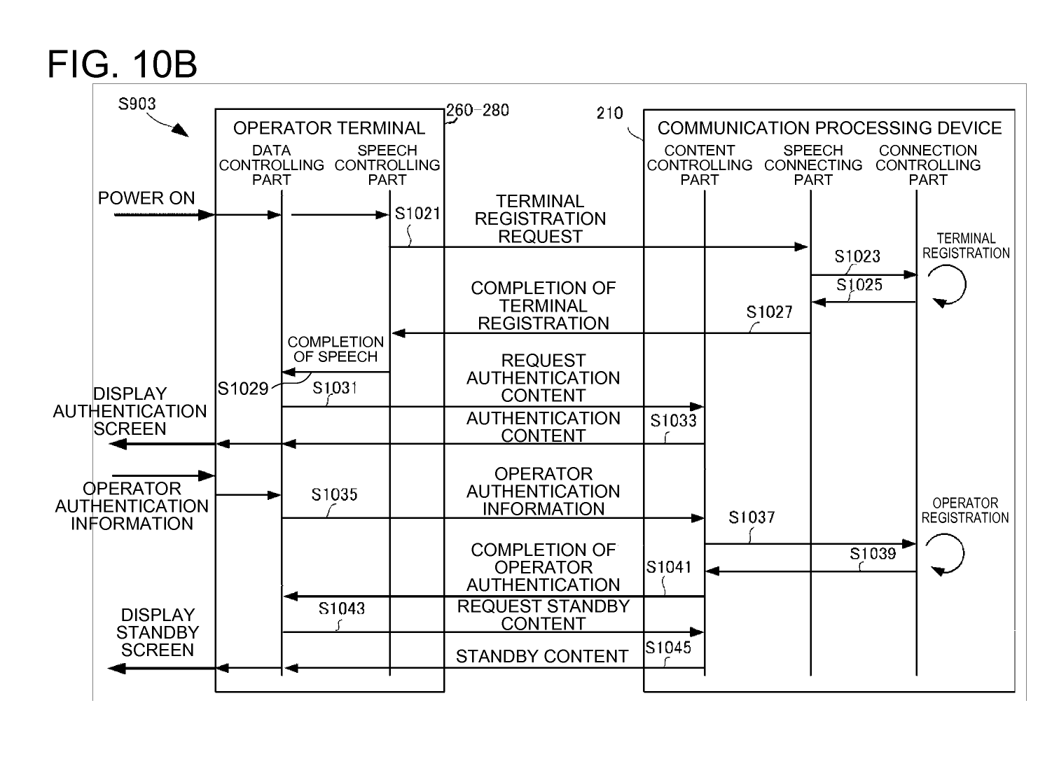

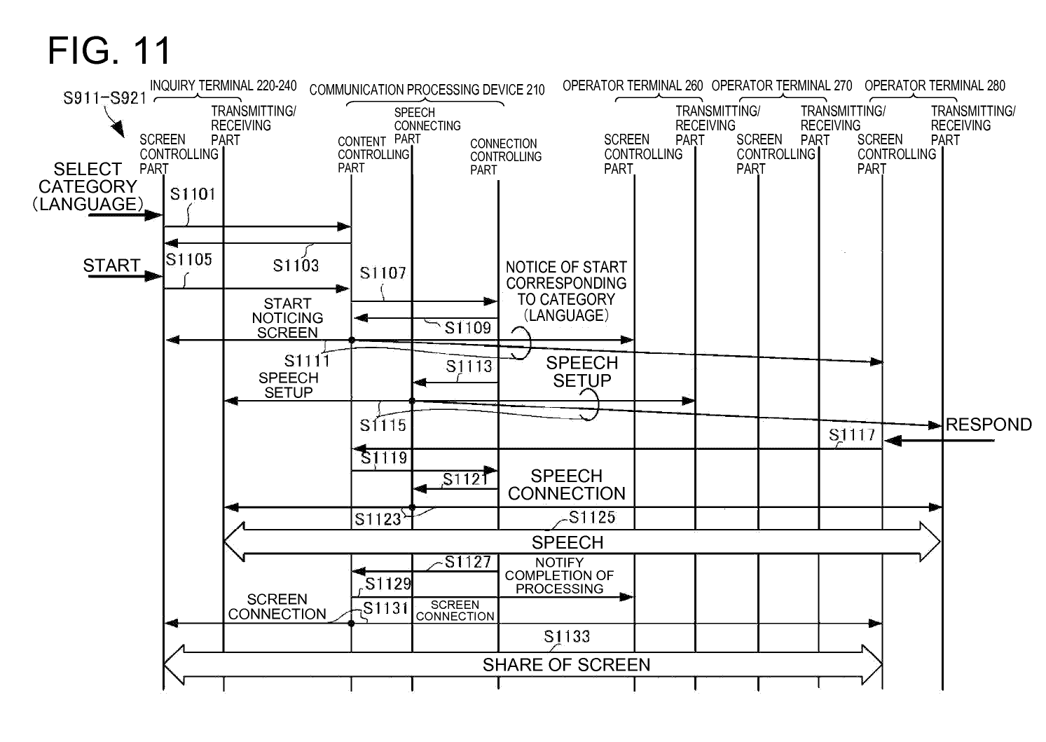

FIG. 9 is a sequence diagram showing an operational procedure 900 by the communication processing system according to this exemplary embodiment. FIG. 9 shows the outline of the whole operational procedure, and the details will be described referring to FIGS. 10A, 10B and 11. Referring to FIG. 9, the inquiry terminal 240 will be described as the representative.

First, initial setup is performed. In the initial setup, the inquiry terminal 240 is powered on and brought to standby (display of an initial screen) in step S901. On the other hand, in step 903, the respective operators select the operator terminals 260 to 280, and usable languages as available attributes are thereby linked to the operator terminals. FIG. 9 shows a case where an operator who can speak Chinese is in charge of the operator terminal 260, an operator who can speak English is in charge of the operator terminal 270, and an operator who can speak Chinese is in charge of the operator terminal 280. In this exemplary embodiment, the available languages are not inputted from the operator terminals. The available languages of the operators are previously associated with the operator IDs and stored in the operator attribute storing part 521. When the operator ID is inputted, the available language of the operator is automatically acquired in the communication processing device 210. After completion of the initial setup, access by an inquirer is waited. All of the operator terminals do not need to be used by the operators. An operator terminal without an operator is excluded from control by the system.

When the inquirer 250 inputs an attribute (a used language) when starting an inquiry, the inquiry terminal 240 transmits the inputted attribute (herein, Chinese) to the communication processing device 210 in step S911. The communication processing device 210 determines that operators who can speak Chinese are in charge of the operator terminals 260 and 280, and informs the operator terminals 260 and 280 that an inquirer who wants to inquire in Chinese is accessing in step S913.

FIG. 9 shows a case where the operator 290 of the operator terminal 280 agrees to respond. In step S915, the operator terminal 280 returns a signal corresponding to a request for response to the communication processing device 210. Because the inquiry is accepted, the communication processing device 210 notifies the other informed operator terminal 260 that the inquiry is already processed (or the inquiry is accepted by the one operator terminal) in step S917. Then, in step S919, the communication processing device 210 sends a request for connection to the inquiry terminal 240 and the operator terminal 280. In step S921, the inquiry terminal 240 and the operator terminal 280 are connected. Speech connection is directly performed by the server (PBX) 213, whereby it becomes possible to talk by using the headset. Data is displayed by the data server 211, for example, in the form of a common screen.

### (Initial Setup of Inquiry Terminal)

FIG. 10A is a sequence diagram showing the operational step S901 in the initial setup of the inquiry terminals 220 to 240 according to this exemplary embodiment. The operational step shown in FIG. 10A is an example, and all steps shown in FIG. 10A do not need to be executed in step S901 shown in FIG. 9 at all times.

When the inquiry terminals 220 to 240 are powered on, the speech controlling part 440 of each of the inquiry terminals 220 to 240 transmits a terminal registration request to the speech connecting part 530 of the communication processing device 210 in step S1001. In the communication processing device 210, the speech connecting part 530 sends a terminal registration request to the connection controlling part 520 in step S1003. Upon finishing registration of the inquiry terminal by the connection controlling part 520, the connection controlling part 520 notifies the speech connecting part 530 that terminal registration is completed in step S1005. The speech connecting part 530 notifies the speech controlling part 440 of each of the inquiry terminals 220 to 240 that terminal registration is completed in step S1007.

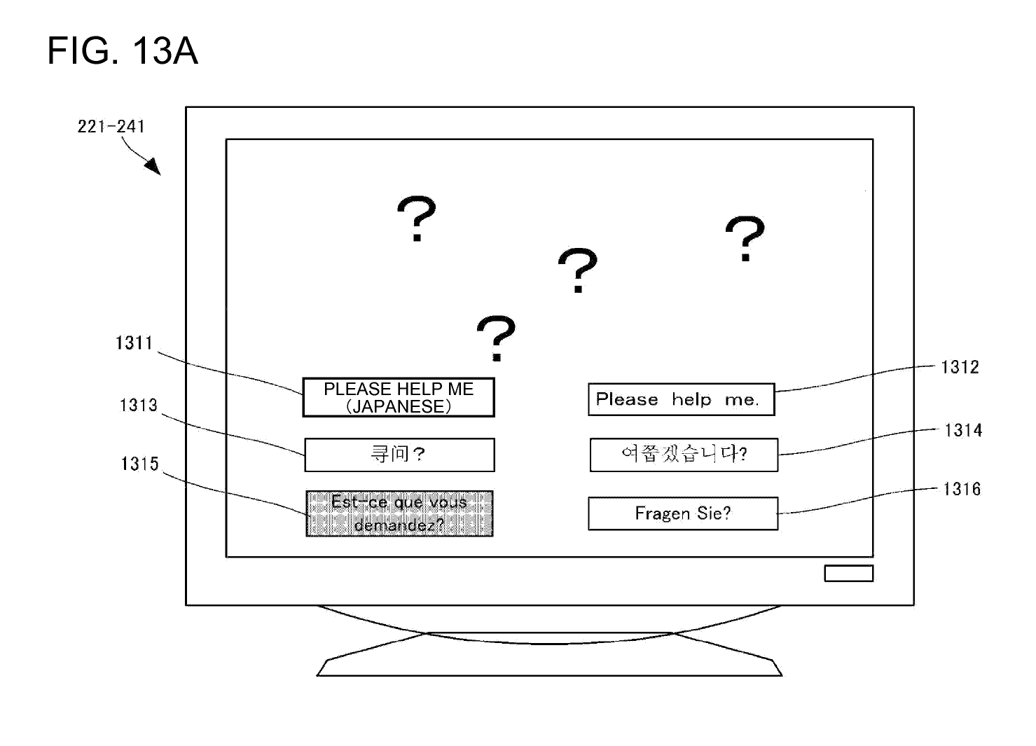

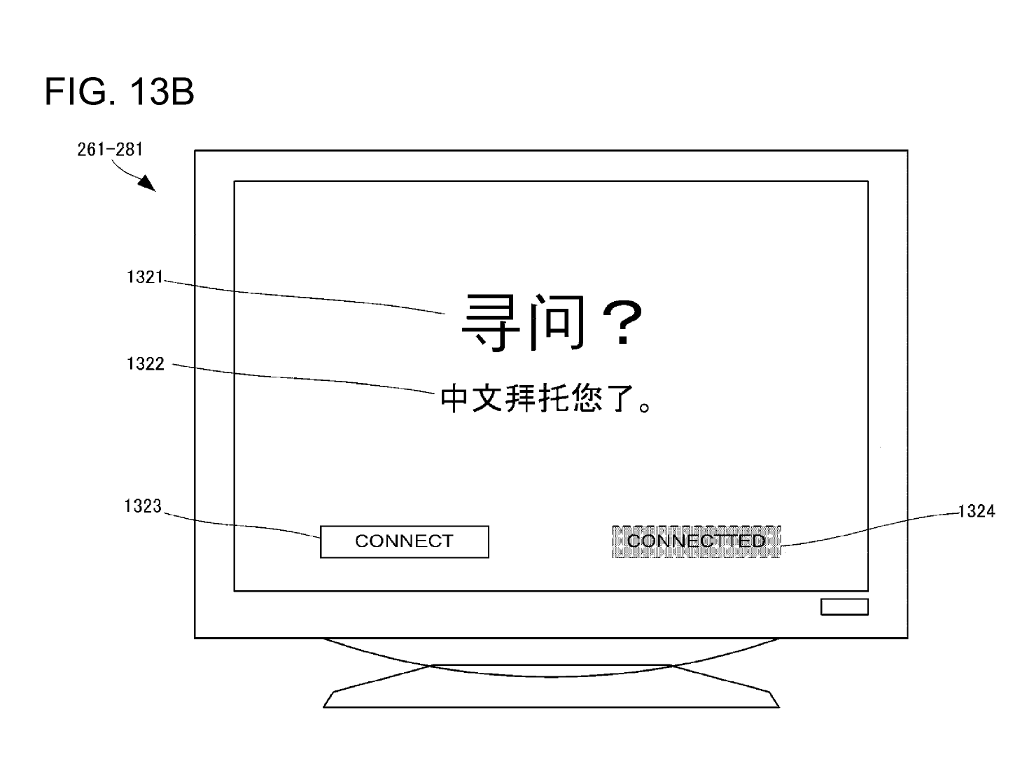

In step S1009, the speech controlling part 440 of each of the inquiry terminals 220 to 240 notifies the data controlling part 420 that the terminal registration process by the speech controlling part 440 is completed. In step S1011, the data controlling part 420 requests the content controlling part 540 of the communication processing device 210 to transmit initial content (including an initial screen). The content controlling part 540 of the communication processing device 210 retrieves initial content from the content DB 212 and, in step S1013, transmits to the data controlling part 420 of each of the inquiry terminals 220 to 240. The data controlling part 420 causes each of the display parts 221 to 241 of the inquiry terminals 220 to 240 to display the initial screen (see FIG. 13A) of the initial content, and waits for access by the inquirers.

### (Initial Setup of Operator Terminal)

FIG. 10B is a sequence diagram showing the operational step S903 in the initial setup of the operator terminals 260 to 280 according to this exemplary embodiment. The operational step shown in FIG. 10B is an example and, in S903 shown in FIG. 9, all steps shown in FIG. 10B do not need to be executed at all times.

When the operator terminals 260 to 280 are powered on, the speech controlling part 440 of each of the operator terminals 260 to 280 transmits a terminal registration request to the speech connecting part 530 of the communication processing device 210 in step S1021. In the communication processing device 210, the speech connecting part 530 sends a terminal registration request to the connection controlling part 520 in step S1023. Upon finishing registration of the operator terminal by the connection controlling part 520, the connection controlling part 520 notifies the speech connecting part 530 that terminal registration is completed in step S1025. The speech connecting part 530 notifies the speech controlling part 440 of each of the operator terminals 260 to 280 that operator registration is completed in step S1027.

In step S1029, the speech controlling part 440 of each of the operator terminals 260 to 280 notifies completion of the terminal registration process by the speech controlling part 440 (speech completion) to the data controlling part 420. In step S1031, the data controlling part 420 requests the content controlling part 540 of the communication processing device 210 to transmit authentication content for operator authentication. The content controlling part 540 of the communication processing device 210 retrieves authentication content from the content DB 212 and, in step S1033, transmits to the data controlling part 420 of each of the operator terminals 260 to 280. The data controlling part 420 causes each of the display parts 261 to 281 of the operator terminals 260 to 280 to display an authentication screen (not shown in the drawings) for the authentication content, and stands by for input of authentication information by the operators. Input by the operators may be accepted through a touchscreen panel (a responder inputting means) of each of the display parts 261 to 281, or may be accepted through an inputting means like a keyboard (not shown in the drawings). Authentication information includes an operator ID for identifying an operator and, if necessary, a password. In this exemplary embodiment, this operator ID is used in the communication processing device 210 as information for associating a second communication terminal (an operator terminal) and the attribute of a responder using the second communication terminal. Besides, authentication information may include the attribute of a responder.

When authentication information from the operator terminals 260 to 280 is inputted, the data controlling part 420 of each of the operator terminals 260 to 280 transmits operator authentication information to the content controlling part 540 of the communication processing device 210 in step S1035. In the communication processing device 210, the content controlling part 540 sends the operator authentication information to the connection controlling part 520 in step S1037. Upon finishing registration of the operator by the connection controlling part 520, the connection controlling part 520 notifies the content controlling part 540 that operator authentication is completed t in step S1039. In step S1041, the content controlling part 540 notifies operator authentication completion (operator registration completion) to the data controlling part 420 of each of the operator terminals 260 to 280.

In step S1043, the data controlling part 420 of each of the operator terminals 260 to 280 requests standby content including standby display to the content controlling part 540 of the communication processing device 210. The content controlling part 540 of the communication processing device 210 retrieves standby content from the content DB 212 and, in step S1045, transmits to the data controlling part 420 of each of the operator terminals 260 to 280. The data controlling part 420 causes the display part to display a standby screen of the standby content.

### (Inquiry Processing)

FIG. 11 is a sequence diagram showing the operational steps S911 to S921 for inquiry processing in the communication processing system 200 according to this exemplary embodiment. The operational steps shown in FIG. 11 are an example and, in steps S911 to S921 shown in FIG. 9, all of the steps shown in FIG. 11 do not need to be executed at all times. The operational steps may be shown by a simplified sequence like S911 to S921 shown in FIG. 9.

When an inquirer selects a category (a used language) on the screen of any of the inquiry terminals 220 to 240, the screen controlling part 430 of the inquiry terminal transmits the used language of the inquirer to the content controlling part 540 of the communication processing device 210 in step S1101. In step S1103, the content controlling part 540 returns a report of reception of the used language of the inquirer. Next, when the inquirer instructs to start an inquiry on the screen, the screen controlling part 430 transmits a notice of start of an inquiry to the content controlling part 540 of the communication processing device 210 in step S1105. In step S1107, the content controlling part of the communication processing device 210 passes the used language of the inquirer to the connection controlling part 520.

The connection controlling part 520 of the communication processing device 210 executes matching between useable languages of operators in charge of the operator terminals 260 to 280 and the inquirer's used language passed by the content controlling part 540. The connection controlling part 520 instructs the content controlling part 540 to transmit a start noticing screen to the operator terminal that the usable language matches the used language in step S1109, and instructs the speech connecting part 530 to produce a speech sound in step S1113. In this exemplary embodiment, because the inquirer speaks in Chinese and operators capable of speaking Chinese are in charge of the operator terminals 260 and 280 (see FIG. 9), the communication processing device 210 (the content controlling part 540 and the speech connecting part 530) transmits an inquiry noticing screen and a speech sound to the operator terminals 260 and 280. Either the noticing screen or the speech sound is not transmitted to the operator terminal 270 because the operator of the operator terminal 270 speaks English.

In step S1111, the content controlling part 540 transmits the start noticing screen to the screen controlling part 430 of the inquiry terminal accessed by the inquirer, and also transmits the inquiry noticing screen to the operator terminals 260 and 280 (see FIG. 13B). Moreover, in step S1115, the speech connecting part 530 transmits the speech sound to the transmitting/receiving part 450 of the inquiry terminal accessed by the inquirer, and also transmits the speech sound to the operator terminals 260 and 280. The noticing screen may display the content of an inquiry in a used language, or may show in a used language only that there is an inquiry.

In the example described referring to FIGS. 9 and 11, it is assumed that the operator of the operator terminal 280 agrees to respond to the inquiry. The screen controlling part 430 of the operator terminal 280 transmits agreement to respond to the content controlling part 540 of the communication processing device 210 in step S1117. In step S1119, the content controlling part 540 notifies the connection controlling part 520 that the operator terminal 280 agrees to respond to the inquiry. In step S1121, the connection controlling part 520 instructs the speech connecting part 530 to establish a speech connection between the inquiry terminal accessed by the inquirer and the operator terminal 280. Moreover, in step S1127, the connection controlling part 520 instructs the content controlling part 540 to establish a screen connection between the inquiry terminal accessed by the inquirer and the operator terminal 280. In step S1123, the speech connecting part 530 instructs the transmitting/receiving part 450 of the inquiry terminal accessed by the inquirer and the transmitting/receiving part 450 of the operator terminal 280 to establish a speech connection. Moreover, in step S1131, the content controlling part 540 instructs the screen controlling part 430 of the inquiry terminal accessed by the inquirer and the screen controlling part 430 of the operator terminal 280 to establish a screen connection. In step S1125, the transmitting/receiving part 450 of the inquiry terminal accessed by the inquirer and the transmitting/receiving part 450 of the operator terminal 280 are connected by the server (PBX) 213, whereby a talk is allowed. On the other hand, in step S1133, the screen controlling part 430 of the inquiry terminal accessed by the inquirer and the screen controlling part 430 of the operator terminal 280 are connected to the content controlling part 540 by the data server 211, whereby share of a display screen for the same content is allowed.

In steps S1109 to S1115 and steps S1121 to S1133, speech sounds and images may be processed simultaneously, may be processed in the order shown in FIG. 11, or may be processed in the opposite order. It is desirable that speech sounds and images are simultaneously processed because the respective processes are executed by functional configuration parts independent of each other.

### <Hardware Configuration of Communication Processing Device>

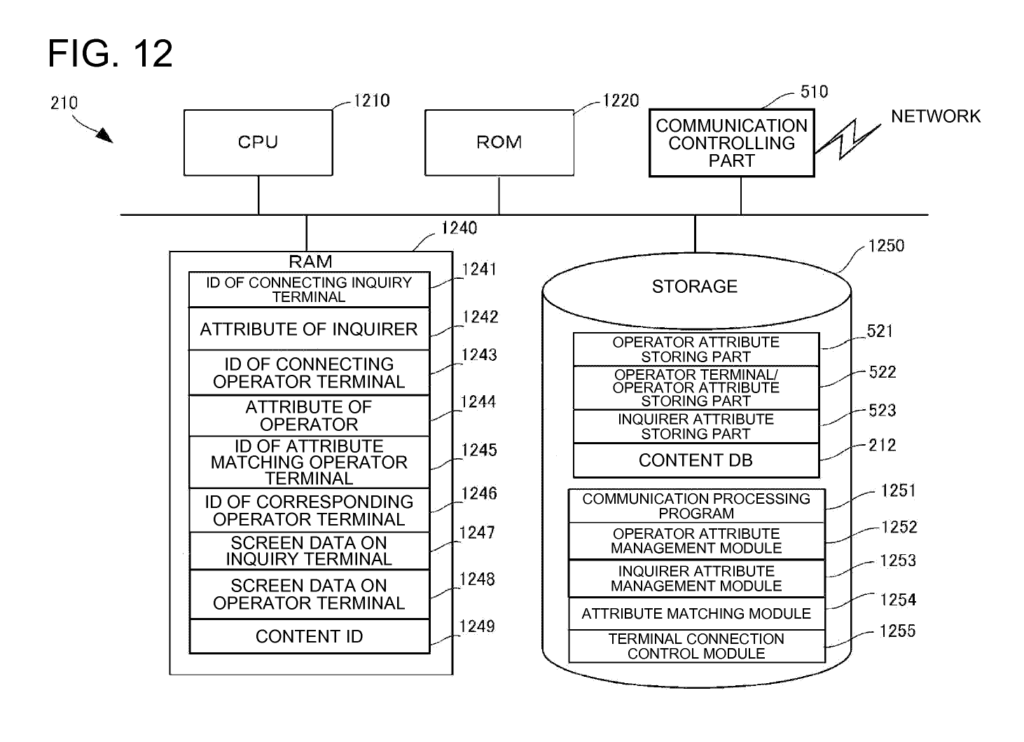

FIG. 12 is a block diagram showing the hardware configuration of the communication processing device 210 according to this exemplary embodiment.

In FIG. 12, a CPU 1210 is a processor for calculation and control, and realizes the respective functional configuration parts shown in FIG. 2 by execution of a program. A ROM 1220 stores fixed data and a program, for example, initial data and a program. A program may be stored in a computer-readable recording medium, instead of the ROM 1220. For example, the recording medium is a portable medium such as a flexible disk, an optical disk, a magneto-optical disk, and a semiconductor memory. The communication controlling part 510 communicates with the inquiry terminals 220 to 240 and the operator terminals 260 to 280 via the network 300. Communication may be wireless or wired.

A RAM 1240 is a random access memory used by the CPU 1210 as a work area for temporary storage. In the RAM 1240, a region for storing data necessary for realization of this exemplary embodiment is secured. Reference numeral 1241 denotes an ID of a currently connected inquiry terminal. Reference numeral 1242 denotes an inquirer's attribute (a used language) selected and inputted from the inquiry terminal with the inquiry terminal ID 1241. Reference numeral 1243 denotes an ID of a currently connected operator terminal. Reference numeral 1244 denotes an attribute (a usable language) of an operator using the operator terminal with the operator terminal ID 1243. Reference numeral 1245 denotes an ID of an operator terminal used by an operator whose attribute matches the inquirer's attribute as a result of matching between the inquirers's used language and usable languages of operators using operator terminals. The number of the operator terminal IDs 1245 can be one or more. Reference numeral 1246 denotes an ID of an operator terminal used by an operator corresponding to the inquiry by the inquirer among the operator terminals with the operator terminal IDs 1245. Reference numeral 1247 denotes a display screen on the inquiry terminal (e.g., see FIG. 13A). Reference numeral 1248 denotes a display screen on the operator terminal (e.g., see FIG. 13B). Reference numeral 1249 denotes a content ID designating the content of an initial screen and an operation screen on the inquiry terminal and the operator terminal, or a content ID instructing the content to be displayed as a shared screen on the inquiry terminal and the operator terminal.

Storage 1250 stores database and various kinds of parameters, and also stores the following data and programs necessary for realization of this exemplary embodiment. Reference numeral 521 denotes the operator attribute storing part 521 shown in FIGS. 5 and 6A. Reference numeral 522 denotes the operator terminal/operator attribute storing part shown in FIGS. 5 and 6C. Reference numeral 523 denotes the inquirer attribute storing part 523 shown in FIGS. 5 and 7. Reference numeral 212 denotes the content DB shown in FIGS. 2, 5 and 8. The storage 1250 stores the following programs. Reference numeral 1251 denotes a communication processing program causing to execute the entire processing. Reference numeral 1252 denotes an operator attribute management module for managing the attributes of operators. Reference numeral 1253 denotes an inquirer attribute management module for managing the attributes of inquirers. Reference numeral 1254 denotes an attribute matching module for performing matching of the attribute of an inquirer and the attribute of an operator. Reference numeral 1255 denotes a terminal connection control module for informing an operator terminal of start of an inquiry based on the result of attribute matching and, when response to the inquiry is agreed, connecting the inquiry terminal and the operator terminal.

In FIG. 12, only data and programs indispensable to this exemplary embodiment are shown, whereas versatile data and programs of the OS and the like are not shown.

### (Display Screen of Inquiry Terminal)

FIG. 13A is a diagram showing a display screen of each of the display parts 221 to 241 of the inquiry terminals 220 to 240 according to this exemplary embodiment. FIG. 13A shows an initial screen. Because this initial screen enough shows the feature of this exemplary embodiment, description of display screens of the other inquiry terminals will be omitted.

FIG. 13A shows an initial screen to stand by for an inquiry from an inquirer. In FIG. 13A, reference numeral 1311 denotes an inquiry button for a person who wants to inquire in Japanese, displaying “Please help me” (Japanese). Likewise, reference numeral 1312 denotes an inquiry button for a person who wants to inquire in English. Reference numeral 1313 denotes an inquiry button for a person who wants to inquire in Chinese. Reference numeral 1314 denotes an inquiry button for a person who wants to inquire in Korean. Reference numeral 1315 denotes an inquiry button for a person who wants to inquire in French. Reference numeral 1316 denotes an inquiry button for a person who wants to inquire in German.

The inquiry button 1315 for a person who wants to inquire in French is displayed with hatching because an operator who can respond to an inquiry in French is absent at present. For example, in a case where an operator who can respond is not registered, in a case where an operator who can respond is registered but absent at present, and in a case where all of operators who can respond are responding to other inquiries, the displaying parts 221 to 241 display so that the inquirer can understand the statuses of the operators. By touching (selecting) any of the effective buttons displayed on each of the display parts 221 to 241 in FIG. 13A, an inquirer can notify the communication processing device 210 from the inquiry terminal that he/she wants to inquire in the selected language. Alternatively, the display parts may simply display buttons representing “Japanese,” “English,” and so on, which may be written in the respective languages or in a common language.

### (Display Screen of Operator Terminal)

FIG. 13B is a diagram showing an inquiry informing display screen of each of the display parts 261 to 281 of the operator terminals 260 to 280 according to this exemplary embodiment. FIG. 13B shows an example displayed on an operator terminal used by an operator who can respond in Chinese to an inquiry in Chinese. Because this screen enough shows the feature of this exemplary embodiment, the description of display screens of the other inquiry terminals will be omitted.

In FIG. 13B, reference numeral 1321 denotes “Please help me” in Chinese. Reference numeral 1322 denotes “Please speak in Chinese” in Chinese. Reference numeral 1323 denotes a button for agreeing to respond. Reference numeral 1324 denotes a display for notifying that response to the inquiry is already completed when another operator terminal agrees to respond. As the completion notification, for example, the color of the display 1324 may change, input by the button 1323 may be suspended, and the screen returns to the standby screen. The description on the button 1323 and the display 1324 may be Chinese.

### <Processing Steps by Communication Processing Device>

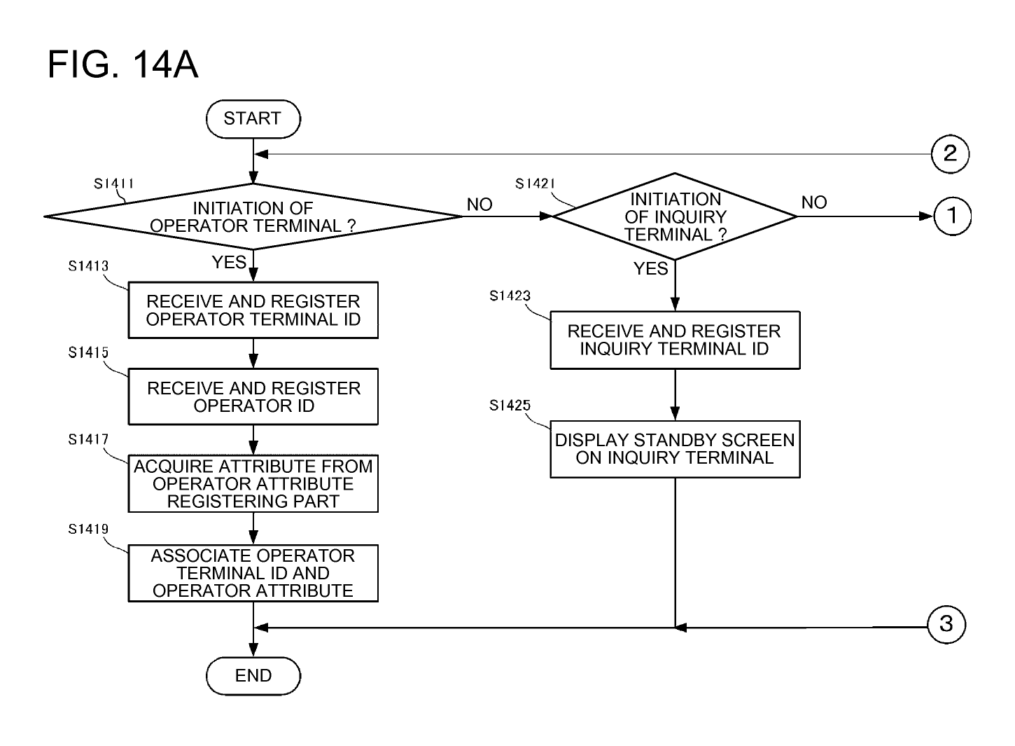

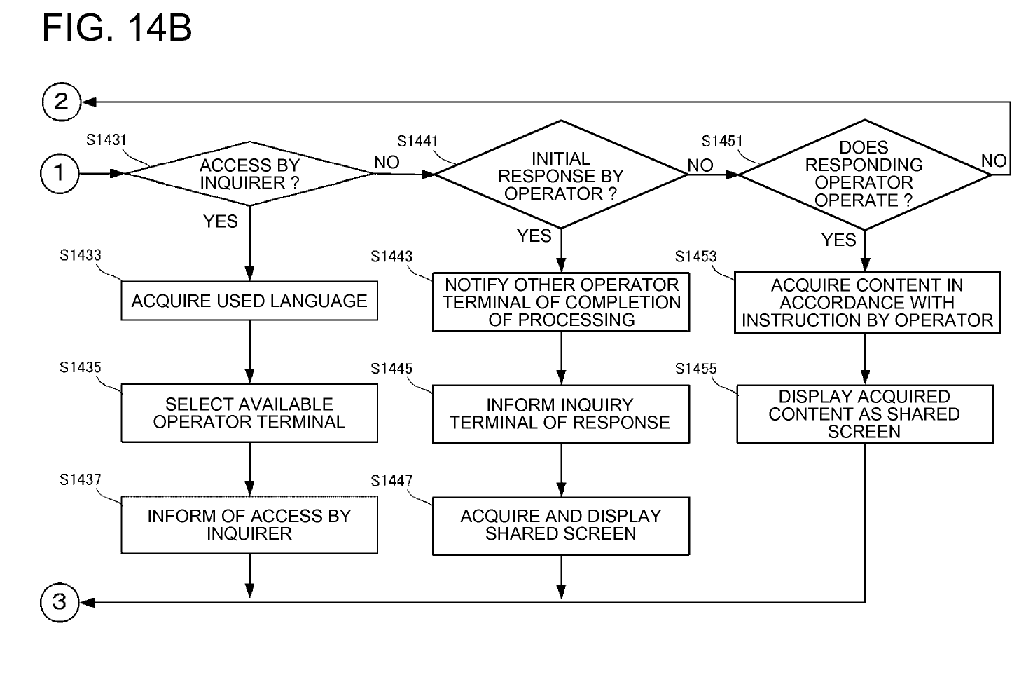

FIGS. 14A and 14B show a flowchart of a processing procedure by the communication processing device 210 according to this exemplary embodiment. The CPU 1210 shown in FIG. 12 executes this flowchart by using the RAM 1240 to realize the respective functional configuration parts shown in FIG. 5. Moreover, although correspondence is not described, this flowchart is included in the communication processing program 1251 stored in the storage 1250 shown in FIG. 12, whereby the respective modules are configured.

First, it is determined in step S1411 of FIG. 14A whether an operator terminal is initiated, and it is determined in step S1421 whether an inquiry terminal is initiated.

When it is determined that an operator terminal is initiated, the connection controlling part 520 receives and stores an operator terminal ID into the operator terminal/operator attribute storing part 522 in step S1413. Next, in step S1415, the connection controlling part 520 receives and stores an operator ID into the operator attribute storing part 521 (also authenticates). In step S1417, the connection controlling part 520 acquires the attribute of the operator from the operator attribute storing part 521 based on the stored operator ID. The connection controlling part 520 associates the operator terminal ID and the operator attribute, and stores into the operator terminal/operator attribute storing part 522.

When it is determined that an inquiry terminal is initiated, the connection controlling part 520 receives and registers an inquiry terminal ID in step S1423. Next, in step S1425, the communication processing device 210 instructs the inquiry terminal to display a standby screen as shown in FIG. 13A, and stands by for access by an inquirer.

The communication processing device 210 determines in step S1431 of FIG. 14B whether an inquirer is accessing through an inquirer terminal, determines in step S1441 whether an operator makes an initial response (agrees to respond) to the inquirer, and determines in step S1451 whether a responding operator operates.

When determining in step S1431 that an inquirer is accessing, the communication processing device 210 acquires a used language of the inquirer in step S1433. The button shown in FIG. 13A is touched (selected) by the inquirer, and the used language of the inquirer is thereby acquired by the inquiry terminal. The used language of the inquirer is transmitted to be acquired by the communication processing device 210. A used language of an inquirer may be inputted by the inquirer in response to a query from an inquiry terminal. Next, in step S1435, the terminal connecting part 525 selects an available (ready for talk) operator terminal based on the result of matching by the attribute matching part 524 between a usable language of an operator linked with an operator terminal stored in the operator terminal/operator attribute storing part 522 and the acquired inquirer's usable language. In step S1437, the selected operator terminal is informed so that access by the inquirer can be distinguished in the used language. The informing method may be use of a display or a speech in the used language as shown in FIG. 13B, or may be notice in a versatile language, or may be use of a logo and a mark as far as the operator can distinguish. The notification method is not limited by the above methods.

On the other hand, when determining in step S1441 that an operator makes an initial response (agrees to respond), in step S1443, the communication processing device 210 notifies the other operator terminals informed of the inquiry that response to the inquiry is already completed. A method for completion notification is not limited as mentioned before. Next, in step S1445, the communication processing device 210 informs the inquiry terminal accessed by the inquirer of a response by the operator. The informing method is not limited as far as the inquirer can understand. In step S1447, the communication processing device 210 acquires a screen retrieved from the content DB 212, and causes the inquiry terminal and the operator terminal connected to each other to display the acquired screen as a common screen. The common screen needs not to be the above display necessarily. An operator may instruct to display a common screen when necessary in accordance with change of the content of an inquiry by an inquirer.

When it is determined in step S1451 that a responding operator operates, content designated by the operator is acquired from the content DB 212 in step S1453. In step S1455, the communication processing device 210 causes the inquiry terminal and the operator terminal to display the acquired content as a common screen. For example, in an airport, many people inquire about a place or a route and, in this case, the same map or floor plan is used for description. Although the above illustration is an example that an operator designates content and causes to display as a common screen, this example is part of an operation by an operator and a process according to another operation by the operator is also executed in the same manner.

Even if a place where the system is used is not an airport but a hotel, information is different, but a service to be provided and the configuration and operation are obvious from the description of this exemplary embodiment. The configuration and operation of this exemplary embodiment can be applied in other remote inquiry systems.

### Third Exemplary Embodiment

Next, a communication processing system according to a third exemplary embodiment of the present invention will be described. The communication processing system according to this exemplary embodiment is different from the second exemplary embodiment in that the attribute of an operator is not previously registered in an operator terminal but inputted when the operator starts to use the operator terminal. Because the other configurations and operations are the same as those of the second exemplary embodiment, the functional configuration of a communication processing device 1510, the processing procedure by the communication processing device 1510, and the configuration of an operator terminal/operator attribute storing part 1522 will be described, and a description of the same configurations and operations as those of the communication processing device 210 shown in FIG. 5 will be omitted. According to this exemplary embodiment, a highly flexible system can be realized because a storage capacity for previously storing the attributes of operators is not necessary and an operator can freely participate in an operation as far as being authenticated.

### <Configuration of Communication Processing Device>

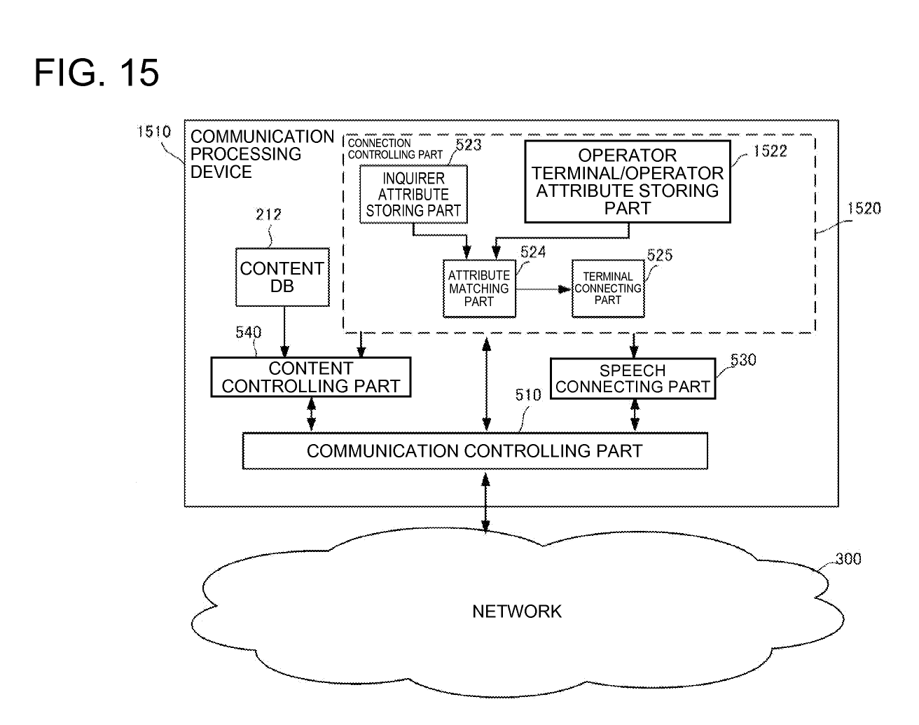

FIG. 15 is a block diagram showing the configuration of the communication processing device 1510 according to this exemplary embodiment. Because the configurations and operations of a connection controlling part 1520, other than the operator terminal/operator attribute storing part 1522, are the same as those of the second exemplary embodiment (the connection controlling part 520 shown in FIG. 5), the same configurations and operations will be denoted by the same reference numerals and a detailed description thereof will be omitted.

The operator terminal/operator attribute storing part 1522 of the connection controlling part 1520 stores the attribute (a usable language) of an operator that the operator inputs when starting to use an operator terminal, in association with the operator terminal.

### (Operator Terminal/Operator Attribute Storing Part)

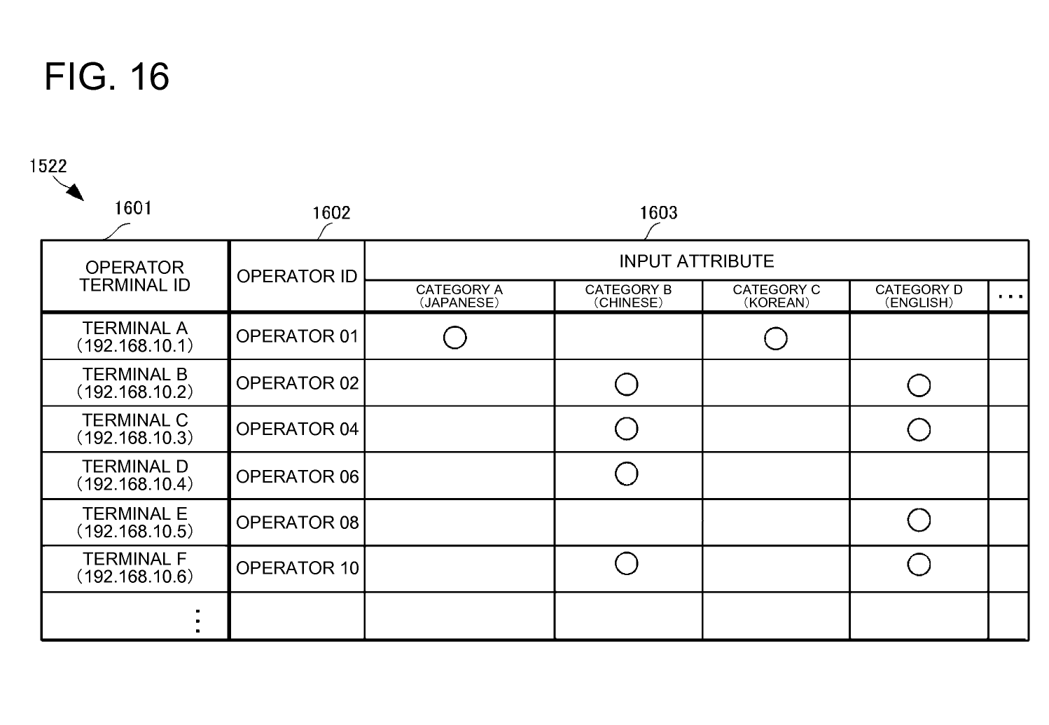

FIG. 16 is a diagram showing the configuration of the operator terminal/operator attribute storing part 1522 according to this exemplary embodiment.

In association with an ID 1601 of an operator terminal, the operator terminal/operator attribute storing part 1522 stores an operator ID 1602 of an operator in charge of the operator terminal and an input attribute 1603 inputted by the operator.

FIG. 16 shows the status of allocation of operators to operator terminals in a like manner as shown in FIG. 6C of the second exemplary embodiment. In FIG. 16, an operator who is not allocated to any operator terminal is not stored. The input attribute 1603 is inputted by an operator when the operator starts to use an operator terminal. Alternatively, the input attribute 1603 may be automatically inputted from an ID card of an operator.

### <Processing Procedure by Communication Processing Device>

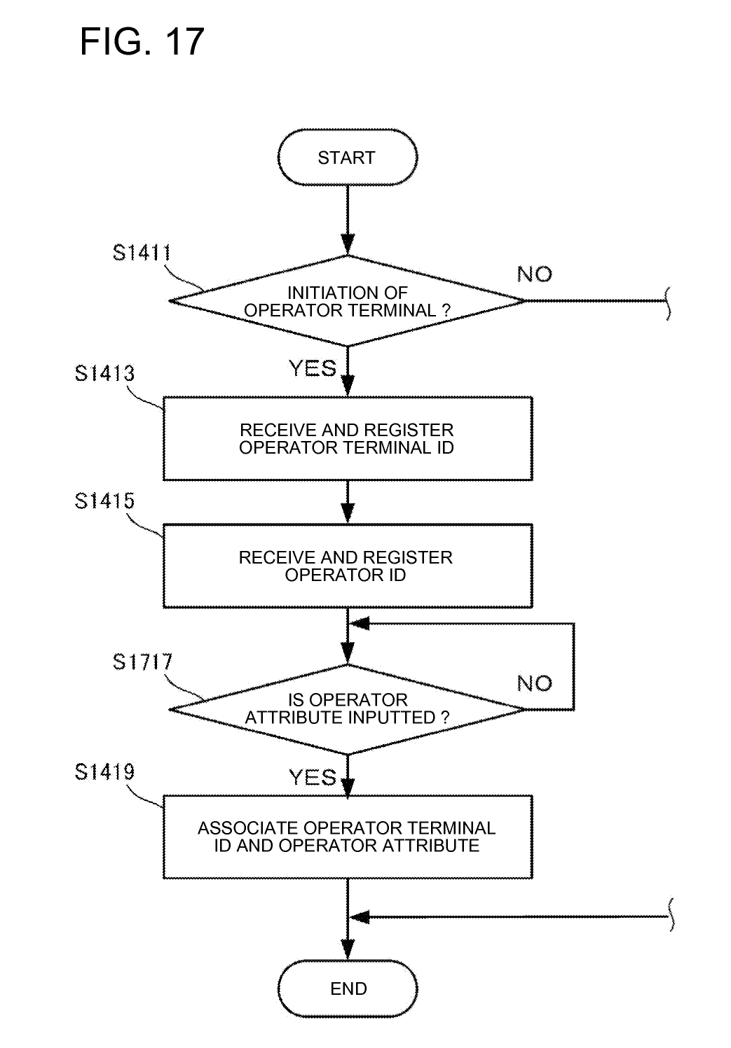

FIG. 17 is a flowchart showing a processing procedure by the communication processing device according to this exemplary embodiment. FIG. 17 is a modification of FIG. 14A of the second exemplary embodiment, in which the processing steps for initialization of an operator terminal are changed. Because the other processing steps are the same as those of the second exemplary embodiment, the illustration and description thereof will be omitted.

When it is determined in step S1411 that an operator terminal is initiated, the communication processing device receives and stores an operator terminal ID in step S1413 and receives and stores an operator ID in step S1415, in the same manner as in the second exemplary embodiment.

After that, in step S1717, the communication processing device stands by for input of an operator attribute. When an operator attribute is inputted, the communication processing device stores the operator terminal ID and the inputted operator attribute in association with each other into the operator terminal/operator attribute storing part 1522 in step S1419. In this exemplary embodiment, an ID of an operator terminal and an operator attribute inputted from the operator terminal are used as information for associating a second communication terminal and the attribute of a responder using the second communication terminal in the communication processing device 1510.

### Fourth Exemplary Embodiment

Next, a communication processing system according to a fourth exemplary embodiment of the present invention will be described. The communication processing system according to this exemplary embodiment is different from the second exemplary embodiment in that, in a case where a used language is taken into consideration as the attribute of an operator, the adequacy of a used language is more strictly determined based on the gender, age, nationality, birthplace, occupation, and so on. For example, a difference in dialect and language depending on generations and a variation of the range of used words are also considered. Because the communication processing system according to this exemplary embodiment is configured to select and connect a matching operator in consideration of not only a used language but also a difference in the same used language, an inquirer can talk with a more adequate operator.

Because the configurations and operations, other than an operator terminal/operator attribute storing part 1810 and an inquirer attribute storing part 1820, are the same as those of the second exemplary embodiment (the connection controlling part 520 shown in FIG. 5), a description thereof will be omitted. Besides, the most adequate operator may be called by, in selection of an operator, sequentially narrowing down operators firstly to operators using the same language and then to operators coming from the same country or region among the operators using the same language.

### (Operator Terminal/Operator Attribute Storing Part and Inquirer Attribute Storing Part)

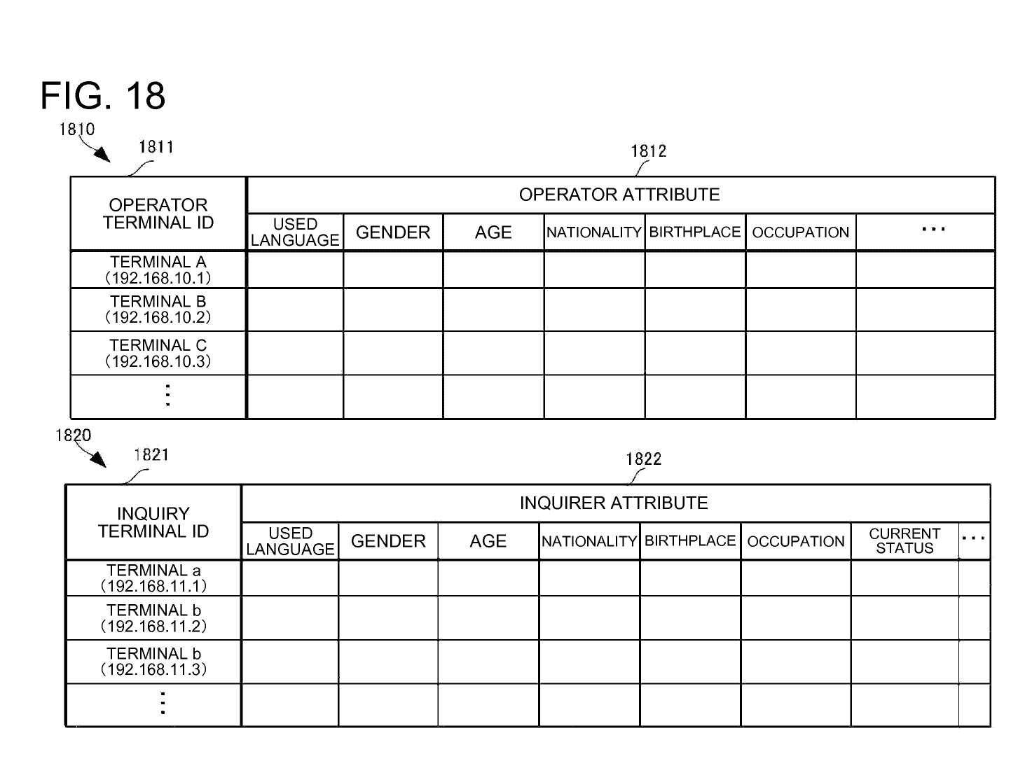

FIG. 18 is a diagram showing the configurations of the operator terminal/operator attribute storing part 1810 and the inquirer attribute storing part 1820 according to this exemplary embodiment.

The operator terminal/operator attribute storing part 1810 stores an operator attribute 1812 in association with an operator terminal ID 1811. The operator attribute 1812 includes not only used language but also gender, age, nationality, birthplace, occupation, and so on. The operator attribute 1812 is taken into consideration at the time of attribute matching, whereby an operator terminal used by a more adequate operator is selected.

The inquirer attribute storing part 1820 stores an inquirer attribute 1822 in association with an inquirer terminal ID 1821. The inquirer attribute 1822 includes not only used language but also gender, age, nationality, birthplace, occupation, current status, and so on. The inquirer attribute 1822 is taken into consideration at the time of attribute matching, whereby an operator terminal used by a more adequate operator is selected. These attributes are also used as information representing the object of an inquiry by an inquirer.

### Fifth Exemplary Embodiment

Next, a communication processing system according to a fifth exemplary embodiment of the present invention will be described. The communication processing system according to this exemplary embodiment is different from the second exemplary embodiment in setting priority at the time of selection of an operator. The communication processing system in this exemplary embodiment is configured to accumulate the number of receptions of inquiries today, the total response time today or the like for each of operators and control so that the operators can receive inquiries as equally as possible. Alternatively, the communication processing system may be configured to control who preferentially responds in a case where a plurality of operators simultaneously agree to respond. According to this exemplary embodiment, it is possible to equally distribute inquiry services to operators, and it is also possible to control when operators simultaneously agree to respond.

This exemplary embodiment is featured by that the processing statuses of operators are accumulated and a processing procedure by a communication processing device are changed. Because the other configurations and operations are the same as those of the second exemplary embodiment, a description thereof will be omitted. Although the priority may be set depending on the experiences and abilities of operators, the priority can be set on operators simply in advance, and such a configuration is also within the scope of the present invention.

### (Processing Statuses of Operators)

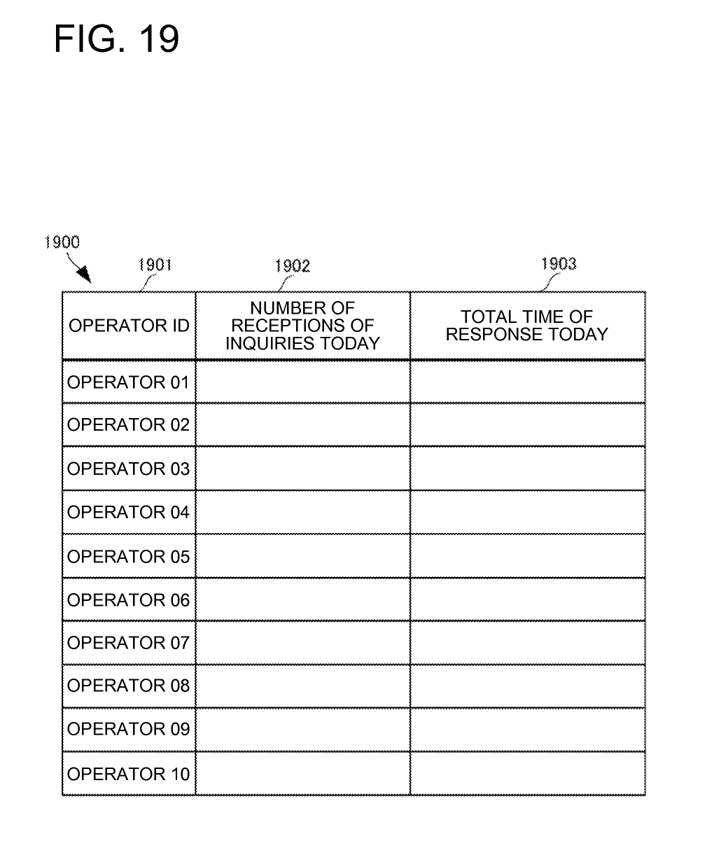

FIG. 19 is a diagram showing the configuration of information 1900 representing the processing statuses of operators according to this exemplary embodiment.

The information 1900 representing the processing statuses of operators stores a number 1902 of receptions of inquiries today and a total time 1903 of response today in association with an operator ID 1901. The number 1902 of receptions of inquiries today and the total time 1903 of inquiries today are cleared when the system is started.

### <Processing Procedure by Communication Processing Device>

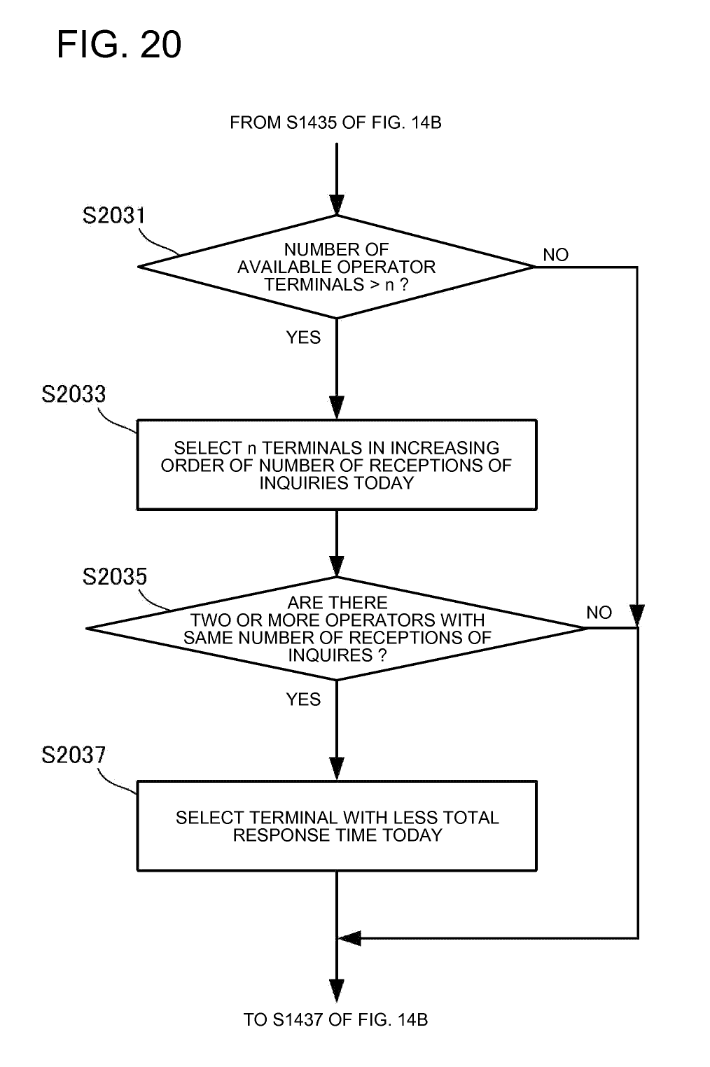

FIG. 20 is a flowchart showing a processing procedure by the communication processing device according to this exemplary embodiment. FIG. 20 shows steps inserted between step S1435 and step S1437 in steps S1431 to S1437 of access by an inquirer shown in FIG. 14B.

After available operator terminals are selected based on a used language in step S1435, the communication processing device determines in step S2031 whether the number of the selected available operator terminals is more than a threshold n (n represents a natural number). In a case where the number of the available operator terminals is more than the threshold n, the communication processing device, in step S2033, refers to the number of receptions of inquiries today in the information 1900 shown in FIG. 19 and selects n available operator terminals in increasing order of the number of receptions of inquiries today.

Next, in step S2035, the communication processing device determines whether there are two or more operators with the same number of receptions of inquiries. In a case where it is determined in step S2035 that there are two or more operators with the same number of receptions of inquiries, the communication processing device selects n operator terminals in increasing order of the total response time today in step S2037.

Then, the communication processing device informs the operators using the selected operator terminals of access by an inquirer so that the used language is obvious.

### Sixth Exemplary Embodiment

Next, a communication processing system according to a six exemplary embodiment of the present invention will be described. The communication processing system according to this exemplary embodiment is different from that of the second exemplary embodiment in not focusing on matching of used languages with a used language as the attribute of an operator but performing matching of various attributes between inquirers and operators so as to be more versatile. This exemplary embodiment enables matching between an inquirer and an operator in various systems, such as a system that an operator can move from one operator terminal to the next. For example, connection from a service center is not fixed to a predetermined operator or operator terminal, and selection corresponding to varying operators is allowed.

Because the configurations and operations, other than an operator terminal/operator attribute storing part 2110 and an inquirer attribute storing part 2120, are the same as those of the second exemplary embodiment (the connection controlling part 520 in FIG. 5), the description thereof will be omitted.

### (Operator Terminal/Operator Attribute Storing Part and Inquirer Attribute Storing Part)

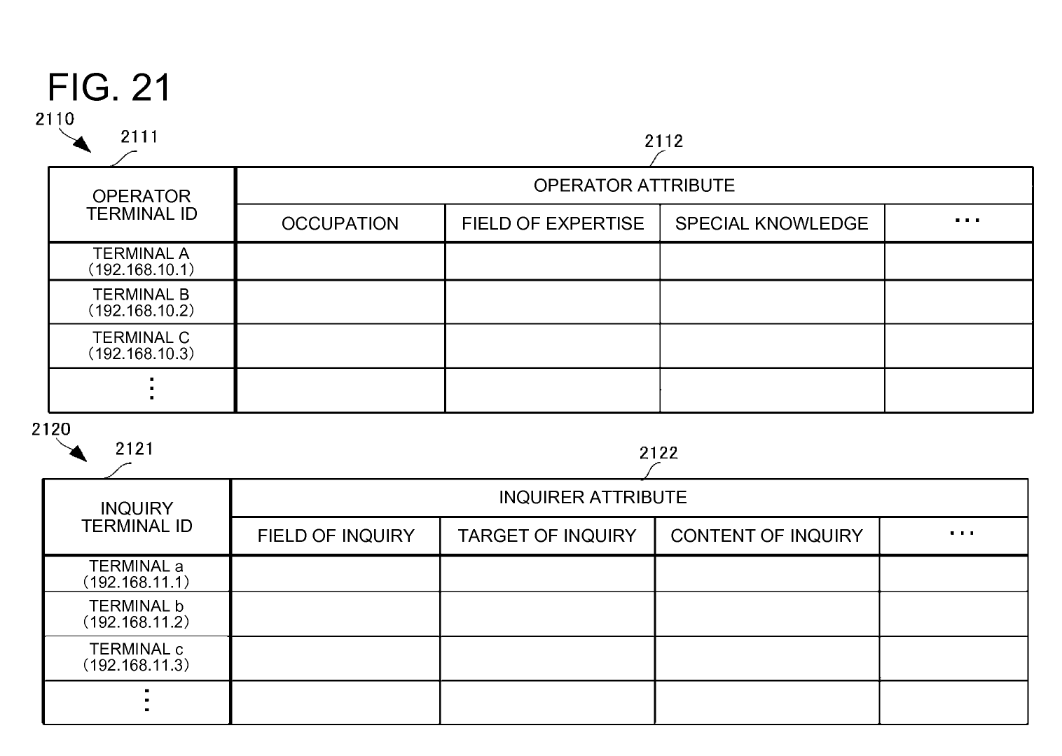

FIG. 21 is a diagram showing the configuration of the operator terminal/operator attribute storing part 2110 and the inquirer attribute storing part 2120 according to this exemplary embodiment.

The operator terminal/operator attribute storing part 2110 stores an operator attribute 2112 in association with an operator terminal ID 2111. The operator attribute 2112 contains operators' occupations, fields of expertise, special knowledge, and so on. The operator attribute 2112 is matched in combination or separately at the time of attribute matching, and an operator terminal used by a more adequate operator is thereby selected.

Further, the inquirer attribute storing part 2120 also stores an inquirer attribute 2122 in association with an inquirer terminal ID 2121. The inquirer attribute 2122 contains the fields, targets and contents of inquiries by inquirers, and so on. The inquirer attribute 2122 is matched in combination or separately at the time of attribute matching, and an operator terminal used by a more adequate operator is thereby selected.

### Another Exemplary Embodiment

The exemplary embodiments of the present invention are described above in detail. Any and all systems or devices by any combinations of the features of the exemplary embodiments fall within the scope of the present invention.

Further, the present invention may be applied to a system configured by a plurality of equipment, or may be applied to a stand-alone device. Moreover, the present invention may also be applied in a case where control programs realizing the functions of the exemplary embodiment are supplied directly or remotely to a system or a device. Accordingly, any and all control programs installed into a computer, mediums for storing the control programs, or WWW (World Wide Web) servers for downloading the control programs in order to realize the functions of the present invention in the computer also fall within the scope of the present invention.

Although the present invention is described above referring to the respective exemplary embodiments, the present invention is not limited to the abovementioned exemplary embodiments. The configurations and details of the present invention can be modified within the scope of the present invention in various manners that can be understood by one skilled in the art.

The present invention is based upon and claims the benefit of priority from Japanese patent application No. 2011-115924, filed on May 24, 2011, the disclosure of which is incorporated herein in its entirety by reference.

### DESCRIPTION OF REFERENCE NUMERALS

100 communication processing system
101 user communication terminal
102 user
103 responder communication terminal
104 responder
120 responder communication terminal information storing part
140 connection controlling part
150 network
200 communication processing system
210 communication processing device
211 data server
212 content DB
213 server (PBX)
220 inquiry terminal
221 display part
222 headset
223 video camera
260 operator terminal
261 display part
262 headset
263 video camera
300 network
400 terminal controlling part
410 communication controlling part
420 data controlling part
430 screen controlling part
440 speech controlling part
450 transmitting/receiving part
510 communication controlling part
520 connection controlling part
521 operator attribute storing part
522 operator terminal/operator attribute storing part
523 inquirer attribute storing part
524 attribute matching part
525 terminal connecting part
530 speech connecting part
540 content controlling part
1210 CPU
1220 ROM
1240 RAM
1250 storage
1510 communication processing device
1520 connection controlling part
1522 operator terminal/operator attribute storing part

What is claimed is:

1. A communication processing system including user communication terminals each operated by a user and responder communication terminals each operated by a responder responding to an inquiry from the user, the communication processing system comprising:
a responder communication terminal information storing unit for associating and storing each of the responder communication terminals and a responder attribute of the responder operating the responder communication terminal; and
a connection controlling unit for controlling to search the responder attribute corresponding to a user attribute of the user by referring to the responder communication terminal information storing unit and connect the responder communication terminal associated with the responder attribute to the user communication terminal.

2. The communication processing system according to claim 1, wherein:
the user communication terminal includes a user inputting unit for accepting the user attribute inputted therein; and
the connection controlling unit includes a notifying unit for, by referring to the responder communication terminal information storing unit searching the responder attribute corresponding to the inputted user attribute accepted by the user inputting unit, and notifying the responder communication terminal associated with the responder attribute of reception of an inquiry from the user.

3. The communication processing system according to claim 2, wherein the notifying unit is configured to notify the responder communication terminal of reception of an inquiry from the user together with the user attribute.

4. The communication processing system according to claim 1, wherein the responder communication terminal includes a responder inputting unit for accepting information inputted therein for associating the responder communication terminal and the responder attribute of the responder operating the responder communication terminal,
the communication processing system further comprising a responder information storing unit for associating and storing an identifier for identifying the responder and the responder attribute, wherein:
the inputted information accepted by the responder inputting unit includes the identifier of the responder operating the responder communication terminal; and
the responder communication terminal information storing unit is configured to associate and store the responder attribute retrieved from the responder information storing unit and the responder communication terminal, based on the identifier of the responder.

5. The communication processing system according to claim 4, wherein:
the inputted information accepted by the responder inputting unit includes the responder attribute of the responder operating the responder communication terminal; and
the responder communication terminal information storing unit is configured to associate and store the responder attribute that the input thereof is accepted by the responder inputting unit and the responder communication terminal.

6. The communication processing system according to claim 1, wherein:
the user attribute includes a used language of the user; and
the responder attribute includes a usable language of the responder.

7. The communication processing system according to claim 1, wherein the responder attribute includes at least one of age, gender, nationality, birthplace and occupation as information for facilitating communication between the user and the responder.

8. The communication processing system according to claim 1, wherein the user attribute includes at least one of age, gender, occupation and current status of the user as information representing an object of an inquiry from the user.

9. The communication processing system according to claim 2, wherein the notifying unit is configured to, when agreement to respond by the responder of one of the responder communication terminals is received, notify the other responder communication terminal except the responder communication terminal transmitting the agreement to respond that the inquiry from the user is already handled.

10. The communication processing system according to claim 9, wherein the notifying unit is configured to, when the agreement to respond by the responder of each of two or more of the responder communication terminals is received, accept the agreement to respond by the responder selected in accordance with a prioritization condition.

11. The communication processing system according to claim 1, wherein the user communication terminals and the responder communication terminals each have a speech controlling unit for controlling output of a speech sound and a screen controlling unit for generating screen data to be displayed on a display part.

12. The communication processing system according to claim 1, further comprising:
a content storing unit for storing content in association with the user attribute; and
an outputting unit for, based on the user attribute and the responder attribute, outputting the content stored in the content storing unit to the user communication terminal and the responder communication terminal associated with the responder attribute so that the user communication terminal and the responder communication terminal can share the content.

13. A method for communication processing by a communication processing system including user communication terminals each operated by a user and responder communication terminals each operated by a responder responding to an inquiry from the user, the communication processing system including a responder communication terminal information storing unit for associating and storing each of the responder communication terminals and a responder attribute of the responder operating the responder communication terminal,
the method comprising controlling to search the responder attribute corresponding to a user attribute of the user by referring to the responder communication terminal information storing unit and connect the responder communication terminal associated with the responder attribute to the user communication terminal.

14. A communication processing device comprising:
a responder communication terminal information storing unit for associating and storing each of responder communication terminals each operated by a responder responding to an inquiry from a user and a responder attribute of the responder operating the responder communication terminal; and
a connection controlling unit for controlling to search the responder attribute corresponding to a user attribute of the user by referring to the responder communication terminal information storing unit and connect the responder communication terminal associated with the responder attribute to the user communication terminal operated by the user.

15. A method for control by a communication processing device including a responder communication terminal information storing unit for associating and storing each of responder communication terminals each operated by a responder responding to an inquiry from a user and a responder attribute of the responder operating the responder communication terminal,
the method comprising controlling to search the responder attribute corresponding to a user attribute of the user by referring to the responder communication terminal information storing unit and connect the responder communication terminal associated with the responder attribute to the user communication terminal operated by the user.

16. A non-transitory computer-readable medium storing a program comprising instructions for causing a communication processing device, which includes a responder communication terminal information storing unit for associating and storing each of responder communication terminals each operated by a responder responding to an inquiry from a user and a responder attribute of the responder operating the responder communication terminal, to realize a connection controlling unit for controlling to search the responder attribute corresponding to a user attribute of the user by referring to the responder communication terminal information storing unit and connect the responder communication terminal associated with the responder attribute to the user communication terminal operated by the user.
